(19) United States
(12) Patent Application Publication
(10) Pub. No.: US 2026/0104671 A1
(43) Pub. Date: Apr. 16, 2026

(54) IMAGE-FORMING APPARATUS INCLUDING DRAWER AND DETACHABLE CARTRIDGE HAVING PROTRUSION CONFIGURED TO BE RECEIVED IN RECESS OF THE DRAWER

(71) Applicant: BROTHER KOGYO KABUSHIKI KAISHA, Nagoya (JP)

(72) Inventor: Nao ITABASHI, Nagoya (JP)

(73) Assignee: BROTHER KOGYO KABUSHIKI KAISHA, Nagoya (JP)

(21) Appl. No.: 19/418,524

(22) Filed: Dec. 12, 2025

Related U.S. Application Data
(63) Continuation of application No. PCT/JP2024/021634, filed on Jun. 14, 2024.

(30) Foreign Application Priority Data
Jun. 27, 2023 (JP) 2023-104801
Jun. 27, 2023 (JP) 2023-104802
Jun. 27, 2023 (JP) 2023-104803

(51) Int. Cl. G03G 21/18

(52) U.S. Cl. CPC G03G 21/1871; G03G 21/1814; G03G 21/1832

(57) ABSTRACT

An image-forming apparatus includes: a main housing; a drawer movable in a first direction relative to the main housing; and a cartridge detachably attachable to the drawer. The drawer includes: a drawer frame; a first drawer electrode; and a second drawer electrode. The cartridge includes: a developing roller and a photosensitive drum each having a shaft extending in a second direction crossing the first direction; a side cover positioned at one end portion of the developing roller in the second direction; and a cartridge electrode positioned at the side cover and electrically connectable to the first and second drawer electrodes. The drawer frame has a first recess recessed in a third direction crossing both the first and second directions. The side cover has a first protrusion protruding in the third direction and configured to be received in the first recess.

### REFERENCE TO RELATED APPLICATIONS

This is a by-pass continuation application of International Application No. PCT/JP2024/021634 filed June 14, 2024 which claims priorities from Japanese Patent Application No. 2023-104801 filed June 27, 2023, Japanese Patent Application No. 2023-104802 filed June 27, 2023, and Japanese Patent Application No. 2023-104803 filed June 27, 2023. The entire contents of the International Application and the priority applications are incorporated herein by reference.

### BACKGROUND ART

A known image-forming apparatus includes a main housing, a drawer movable relative to the main housing, and cartridges detachably attachable to the drawer. Another known image-forming apparatus includes a main housing, a drawer that can be pulled out from the main housing, a cartridge attachable to the drawer, a pressing member configured to press an upper surface of the cartridge, a main cover configured to open and close an opening of the main housing, and an interlocking mechanism configured to move the pressing member in conjunction with a closing operation of the main cover.

In the image-forming apparatus of the first known example, the drawer includes a first electrode. The cartridge includes a second electrode that can contact the first electrode. The main housing includes a controller. The drawer includes a drum circuit board. Each cartridge includes a toner circuit board. The controller is connected to the drum circuit board. The drum circuit board is connected to each of the toner circuit boards.

In the image-forming apparatus of the second known example, the pressing member presses the cartridge in conjunction with the closing operation of the main cover, so that the drawer is pressed against the main housing through the cartridge.

### SUMMARY

In the configuration of the first known example where the electrode of each cartridge is made in contact with the electrode of the drawer, enhanced accuracy is required in positioning the electrode of each cartridge relative to the electrode of the drawer.

In view of the foregoing, it is an object of the present disclosure to improve positional accuracy of the electrode of the cartridge relative to the electrode of the drawer.

Further, in the known image-forming apparatus of the first known example, by providing a new electrical circuit passing through the main housing, the drawer, and the cartridges, there arises a possibility that the new electrical circuit can be repurposed for various applications.

It is therefore another object of the present disclosure to provide an image-forming apparatus in which a new electrical circuit passing through a main housing, a drawer, and a cartridge is formed.

Still further, in the known image-forming apparatus of the second known example, the interlocking mechanism is employed for interlocking the main cover and the pressing member, which may lead to an increase in size of the apparatus.

It is still another object of the present disclosure to reduce a size of an image-forming apparatus in which a drawer can be pressed against a main housing.

In order to attain the above and other objects, according to one aspect, the present disclosure provides an image-forming apparatus including a main housing, a drawer, and a cartridge. The main housing includes a first main-body contact and a second main-body contact. The drawer is movable in a first direction relative to the main housing. The drawer includes: a drawer frame; a first drawer electrode configured to be electrically connected to the first main-body contact; and a second drawer electrode configured to be electrically connected to the second main-body contact. The cartridge is attachable to and detachable from the drawer. The cartridge includes: a developing roller including a developing shaft extending in a second direction crossing the first direction; a photosensitive drum including a drum shaft extending in the second direction; a side cover positioned at one end portion of the developing roller in the second direction; and a cartridge electrode positioned at the side cover. The cartridge electrode is configured to be electrically connected to both the first drawer electrode and the second drawer electrode. The drawer frame has a first recess recessed in a third direction crossing both the first direction and the second direction. The side cover has a first protrusion protruding in the third direction. The first protrusion is configured to be received in the first recess.

With this configuration, since the first protrusion of the side cover having the cartridge electrode is received in the first recess of the drawer frame, positional accuracy of the cartridge electrode relative to the first drawer electrode or the second drawer electrode can be improved.

### BRIEF DESCRIPTION OF DRAWINGS

FIG. 1 is a perspective view illustrating an image-forming apparatus in a state where a drawer is pulled out.

FIG. 2 is a perspective view illustrating a state where the drawer is in an attached position.

FIG. 3 is a cross-sectional view of a cartridge.

FIG. 4 is a perspective view illustrating an interior of a main housing as viewed from one side in a second direction and one side in a third direction.

FIG. 5A is a perspective view illustrating the interior of the main housing as viewed from the other side in the second direction and the other side in the third direction.

FIG. 5B is an enlarged view illustrating a structure around a second main-body electrode.

FIG. 6 is a perspective view of the drawer as viewed from the other side in a first direction and the other side in the second direction.

FIG. 7 is a perspective view of the drawer as viewed from one side in the first direction and the other side in the second direction.

FIG. 8A is a view illustrating a structure around a pressing lever in a state where the pressing lever is in a first lever position.

FIG. 8B is a view illustrating the structure around the pressing lever in a state where the pressing lever is in a second lever position.

FIGS. 9A through 9C are views illustrating how the pressing lever moves while the drawer moves toward the attached position.

FIG. 10 is a perspective view of the cartridge as viewed from the one side in the second direction.

FIG. 11 is a perspective view illustrating a state of the cartridge in a state where a side cover is detached.

FIG. 12 is a perspective view of the cartridge as viewed from the other side in the second direction.

FIG. 13A is a perspective view illustrating a relationship between the side cover and a cartridge electrode.

FIG. 13B is a perspective view of the cartridge electrode.

FIG. 14A is a side view of the drawer to which the cartridges are attached as viewed from the one side in the second direction.

FIG. 14B is an enlarged view illustrating a structure around a first recess and a second recess.

FIG. 15A is a side view of the drawer to which the cartridges are attached as viewed from the other side in the second direction.

FIG. 15B is an enlarged view illustrating a structure around a third recess and a fourth recess.

FIGS. 16A through 16C are views illustrating lengths in the second direction of the first recess and the second recess.

FIG. 17 is a perspective view illustrating a state where a second cartridge is being attached to the drawer to which cartridges other than the second cartridge have already been attached.

FIG. 18A illustrates a state where a one-side contact of the second cartridge is being guided by an inclined surface of a first cartridge.

FIG. 18B illustrates a state where a first protrusion of the second cartridge is being guided by a guide surface of the drawer.

FIG. 19A is a view illustrating a relationship between the one-side contact of the second cartridge and the inclined surface of the first cartridge.

FIG. 19B is a view illustrating a relationship between the one-side contact of the second cartridge and an other-side contact of the first cartridge.

FIG. 20A is a view illustrating a relationship between a recess of the drawer and a boss of a side frame of the main housing.

FIG. 20B is a view illustrating a state where the side frame supports a belt unit.

FIGS. 21A and 21B are views illustrating a state where a drawer protrusion is supported by a main-body protrusion.

FIGS. 22A through 22C are views illustrating a state where a guide rail of the drawer is guided by a guide surface of the main housing.

FIGS. 23A through 23C are views illustrating a relationship among the guide rail, the guide surface, and a recess of the main housing in a state where the drawer is at the attached position.

FIGS. 24A through 24C are views illustrating how a pressing projection of the drawer is pressed by a cam surface of the main housing while the drawer moves toward the attached position.

FIG. 25 is a view illustrating that the pressing projection passes between each developing joint and a corresponding drum joint while the drawer is moving.

FIG. 26 is a perspective view illustrating a modified arrangement of the pressing projection.

FIGS. 27A and 27B are views illustrating a modification to the embodiment in which the third recesses are arranged at different pitches for each model.

### DESCRIPTION

Next, an embodiment of the present disclosure will be described in detail with reference to accompanying drawings.

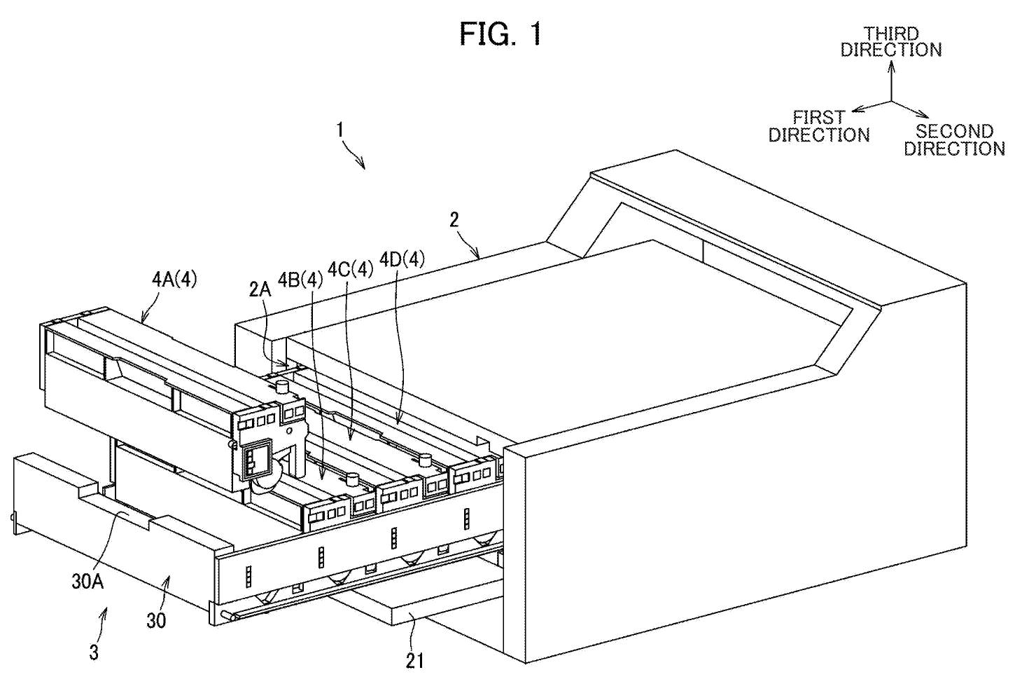

As illustrated in FIG. 1, an image-forming apparatus 1 according to the embodiment is a color printer. The image-forming apparatus 1 includes a main housing 2, a drawer 3, and four cartridges 4.

In the following description, directions will be referred to using a first direction, a second direction, and a third direction shown in the drawings. In the present embodiment, the second direction is orthogonal to the first direction. The third direction is orthogonal to both the first direction and the second direction. Further, each arrow in the drawings indicates one side in the corresponding direction. Also, an end portion of a component at one side in each direction will be referred to as "one end portion of the component in the corresponding direction," and an end portion of the component at the other side in each direction will be referred to as "the other end portion of the component in the corresponding direction" as appropriate.

The main housing 2 has an opening 2A and a main cover 21. The opening 2A is an opening through which the drawer 3 can pass. The main cover 21 is configured to open and close the opening 2A.

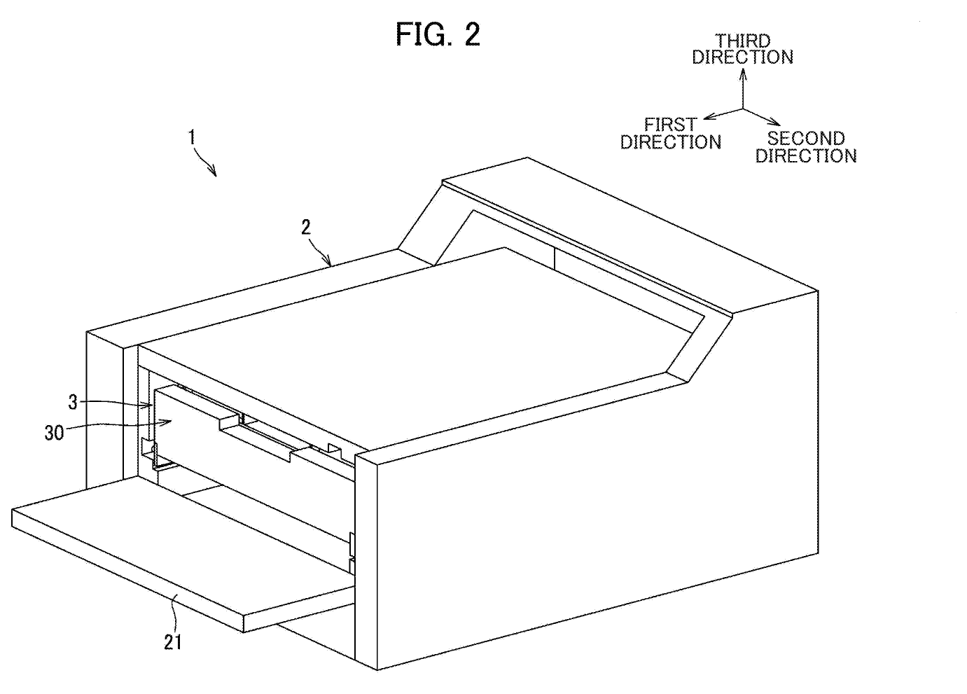

The drawer 3 is movable in the first direction relative to the main housing 2. The drawer 3 is movable between an attached position illustrated in FIG. 2 and a pulled-out position illustrated in FIG. 1.

The attached position is a position of the drawer 3 in which the drawer 3 is located inside the main housing 2. When the drawer 3 is in the attached position, printing can be performed on a sheet. The pulled-out position is a position of the drawer 3 in which at least a part of the drawer 3 is located outside the main housing 2. The pulled-out position is further toward the one side in the first direction relative to the attached position. When the drawer 3 is in the pulled-out position, the cartridges 4 can be attached to and detached from the drawer 3.

The drawer 3 includes a drawer frame 30 and a handle 30A. The handle 30A is positioned at one end portion of the drawer frame 30 in the first direction.

The cartridges 4 are attachable to and detachable from the drawer frame 30. Specifically, the cartridges 4 are attachable to the drawer frame 30 toward the other side in the third direction. The cartridges 4 are detachable from the drawer frame 30 toward the one side in the third direction.

The four cartridges 4 are arranged in the first direction when attached to the drawer frame 30. The four cartridges 4 have the same structure as each other, and are filled with toner of different colors. In the following description, the cartridges 4 may also be referred to as a first cartridge 4A, a second cartridge 4B, a third cartridge 4C, and a fourth cartridge 4D in order from the one side in the first direction, respectively. Further, components constituting the first cartridge 4A may be prefixed with "first" and suffixed with "A" in reference numerals thereof, wherever appropriate. Similarly, components constituting the cartridges 4 other than the first cartridge 4A may be prefixed and suffixed with "second, B," "third, C," and "fourth, D," respectively, in reference numerals thereof, wherever appropriate.

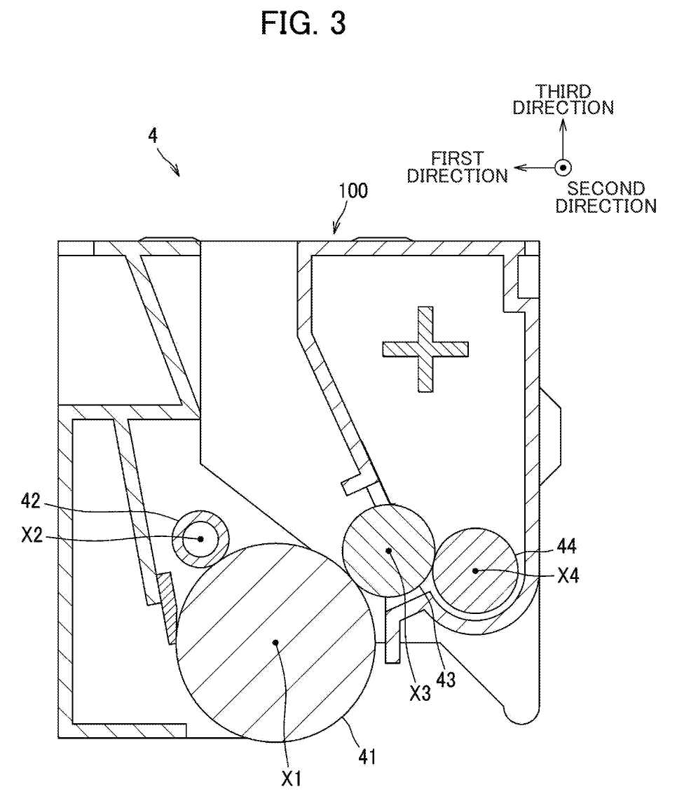

As illustrated in FIG. 3, each cartridge 4 includes a photosensitive drum 41, a charging roller 42, a developing roller 43, a supply roller 44, and a cartridge frame 100.

In other words, the first cartridge 4A includes a first photosensitive drum 41A, a first charging roller 42A, a first developing roller 43A, a first supply roller 44A, and a first cartridge frame 100A. The second cartridge 4B includes a second photosensitive drum 41B, a second charging roller 42B, a second developing roller 43B, a second supply roller 44B, and a second cartridge frame 100B. Likewise, each of the third cartridge 4C and the fourth cartridge 4D also includes the above-described components.

The photosensitive drum 41 is rotatable about a drum shaft X1 extending in the second direction. The photosensitive drum 41 is positioned at the other end portion of the cartridge 4 in the third direction. A surface of the photosensitive drum 41 is configured to be charged by the charging roller 42. After being charged, the surface of the photosensitive drum 41 is configured to be exposed to light by a scanner (not illustrated).

The charging roller 42 is a roller configured to charge the surface of the photosensitive drum 41. The charging roller 42 is in contact with the photosensitive drum 41. The charging roller 42 is rotatable about a charging axis X2 extending in the second direction.

The developing roller 43 is a roller configured to supply toner to the photosensitive drum 41. The developing roller 43 is in contact with the photosensitive drum 41. The developing roller 43 is rotatable about a developing axis X3 extending in the second direction.

The supply roller 44 is a roller configured to supply toner to the developing roller 43. The supply roller 44 is in contact with the developing roller 43. The supply roller 44 is rotatable about a supply axis X4 extending in the second direction.

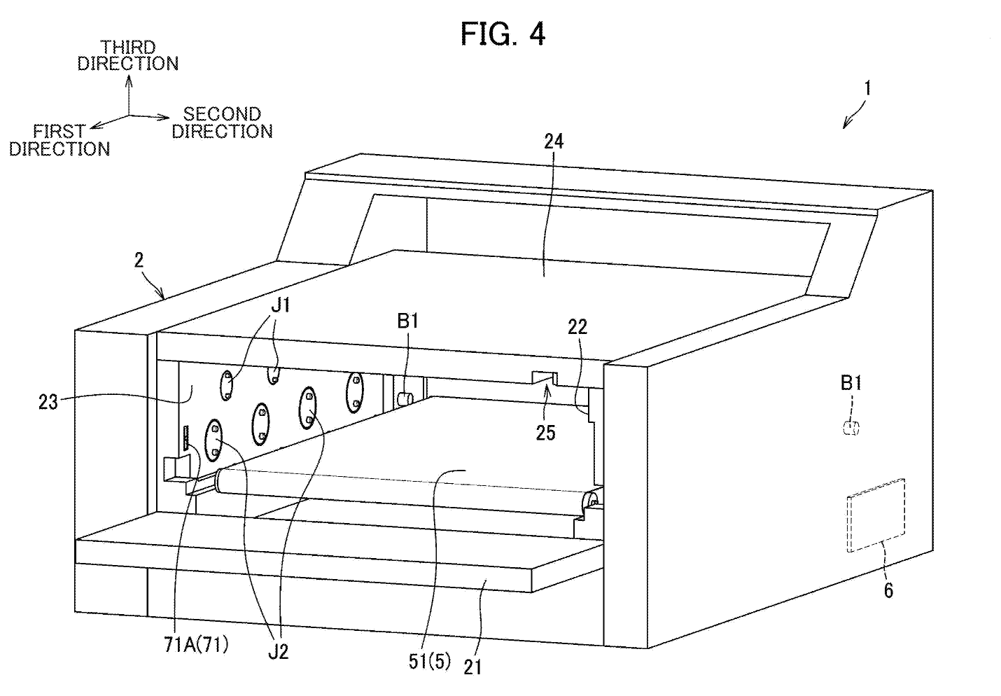

As illustrated in FIG. 4, the image-forming apparatus 1 further includes a belt unit 5, a fixing device (not illustrated), and a controller 6. The belt unit 5 includes a belt 51. The belt 51 is a belt onto which a toner image is to be transferred from each cartridge 4. The belt 51 is configured to contact the photosensitive drums 41.

The controller 6 is configured to execute print control. When the controller 6 executes the print control, a sheet (not illustrated) is started to be conveyed, and a toner image is transferred from the belt 51 onto the sheet. As the sheet passes through the fixing device, the toner image is fixed onto the sheet. After passing through the fixing device, the sheet is discharged outside the main housing 2.

The main housing 2 includes four developing joints J1, four drum joints J2, a first main-body electrode 71, two side frames 22 and 23, and an upper frame 24.

Each developing joint J1 is a member configured to transmit a driving force to the corresponding developing roller 43. The four developing joints J1 are arranged at intervals in the first direction. Each developing joint J1 is movable in the second direction.

Each drum joint J2 is a member configured to transmit a driving force to the corresponding photosensitive drum 41. The four drum joints J2 are arranged at intervals in the first direction. Each drum joint J2 is positioned further toward the other side in the third direction relative to the corresponding developing joint J1. Each drum joint J2 is movable in the second direction.

The first main-body electrode 71 is connected to the controller 6 via a wiring (not illustrated). The first main-body electrode 71 includes a first main-body contact 71A. The first main-body electrode 71 is movable in the second direction.

The side frame 22 is positioned at one end portion of the main housing 2 in the second direction. The side frame 23 is positioned at the other end portion of the main housing 2 in the second direction. The two side frames 22 and 23 support the belt unit 5.

Each developing joint J1, each drum joint J2, and the first main-body electrode 71 are positioned on the side frame 23 at the other side in the second direction. Each developing joint J1, each drum joint J2, and the first main-body electrode 71 are movable toward the one side in the second direction in conjunction with a closing operation of the main cover 21. Each developing joint J1, each drum joint J2, and the first main-body electrode 71 are movable toward the other side in the second direction in conjunction with an opening operation of the main cover 21.

Incidentally, the interlocking of each developing joint J1, each drum joint J2, and the first main-body electrode 71 with the main cover 21 may be mechanically achieved by a linkage mechanism configured to operate in conjunction with the movement of the main cover 21. Alternatively, the interlocking of each developing joint J1, each drum joint J2, and the first main-body electrode 71 with the main cover 21 may be achieved by the controller 6 controlling a drive source for moving each developing joint J1, each drum joint J2, and the first main-body electrode 71 depending on whether the controller 6 detects the main cover 21 is opened or closed.

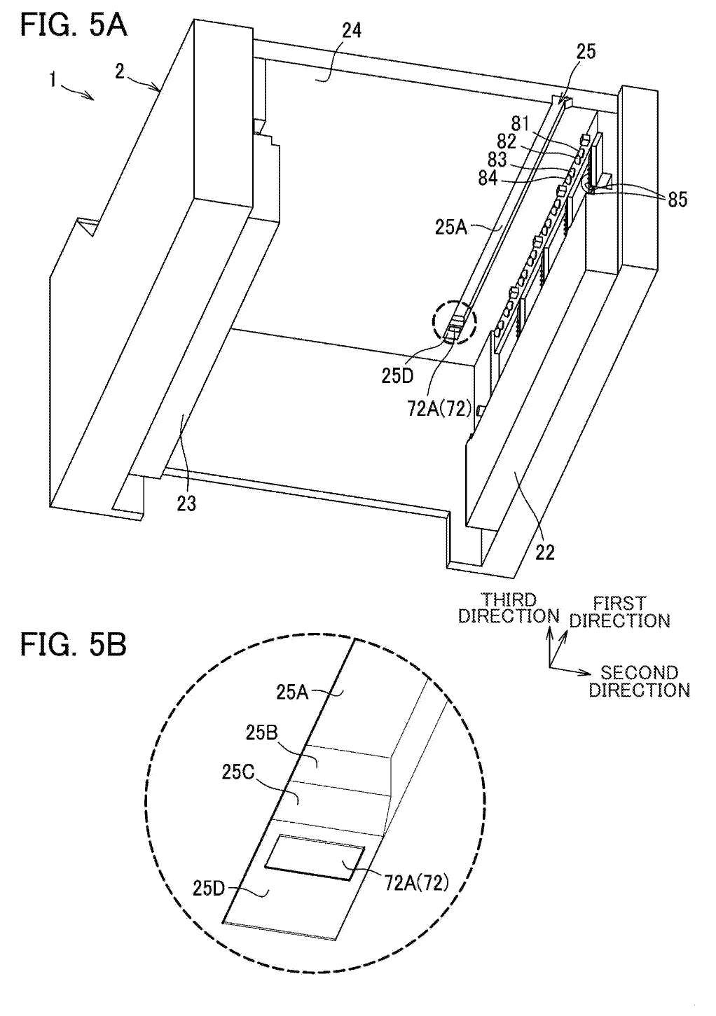

The upper frame 24 connects one end portion of the side frame 22 in the third direction and one end portion of the side frame 23 in the third direction to each other. As illustrated in FIG. 5A, the upper frame 24 has a groove 25. The groove 25 extends in the first direction. The groove 25 is recessed from a surface of the upper frame 24 at the other side in the third direction. The groove 25 is open toward the other side in the third direction and toward the one side in the first direction.

As illustrated in FIGS. 5A and 5B, the groove 25 has a first bottom surface 25A, a second bottom surface 25B, a third bottom surface 25C, and a fourth bottom surface 25D.

The first bottom surface 25A is orthogonal to the third direction. The first bottom surface 25A extends in the first direction, from one end portion of the upper frame 24 in the first direction, toward the other end portion of the upper frame 24 in the first direction.

The second bottom surface 25B extends toward the other side in the third direction from the other end portion of the first bottom surface 25A in the first direction. The second bottom surface 25B is orthogonal to the first bottom surface 25A.

The third bottom surface 25C extends, from the other end portion of the second bottom surface 25B in the third direction, toward the other side in the third direction and toward the other side in the first direction. The third bottom surface 25C is inclined relative to the first bottom surface 25A.

The fourth bottom surface 25D extends, from the other end portion of the third bottom surface 25C in the first direction, toward the other side in the first direction. The fourth bottom surface 25D is orthogonal to the third direction.

The main housing 2 further includes a second main-body electrode 72, and four sets of: a main-body charging electrode 81; a main-body drum electrode 82; a main-body developing electrode 83; a main-body supply electrode 84; and a plurality of main-body memory electrodes 85.

The second main-body electrode 72, and each of the main-body charging electrode 81, the main-body developing electrode 83, the main-body supply electrode 84 and the main-body memory electrodes 85 are connected to the controller 6 via wiring (not illustrated). The main-body drum electrode 82 in each set is grounded.

The second main-body electrode 72 includes a second main-body contact 72A. The second main-body electrode 72 is positioned on the fourth bottom surface 25D of the groove 25 of the upper frame 24.

The main-body charging electrode 81, the main-body drum electrode 82, the main-body developing electrode 83, the main-body supply electrode 84, and the main-body memory electrodes 85 are positioned on the side frame 22 at the one side in the second direction.

The main-body charging electrode 81 is an electrode for supplying power to the corresponding charging roller 42. The main-body drum electrode 82 is an electrode for grounding the corresponding photosensitive drum 41.

The main-body developing electrode 83 is an electrode for supplying power to the corresponding developing roller 43. The main-body supply electrode 84 is an electrode for supplying power to the corresponding supply roller 44. The main-body memory electrodes 85 are electrodes for supplying power to a corresponding cartridge memory M (described later).

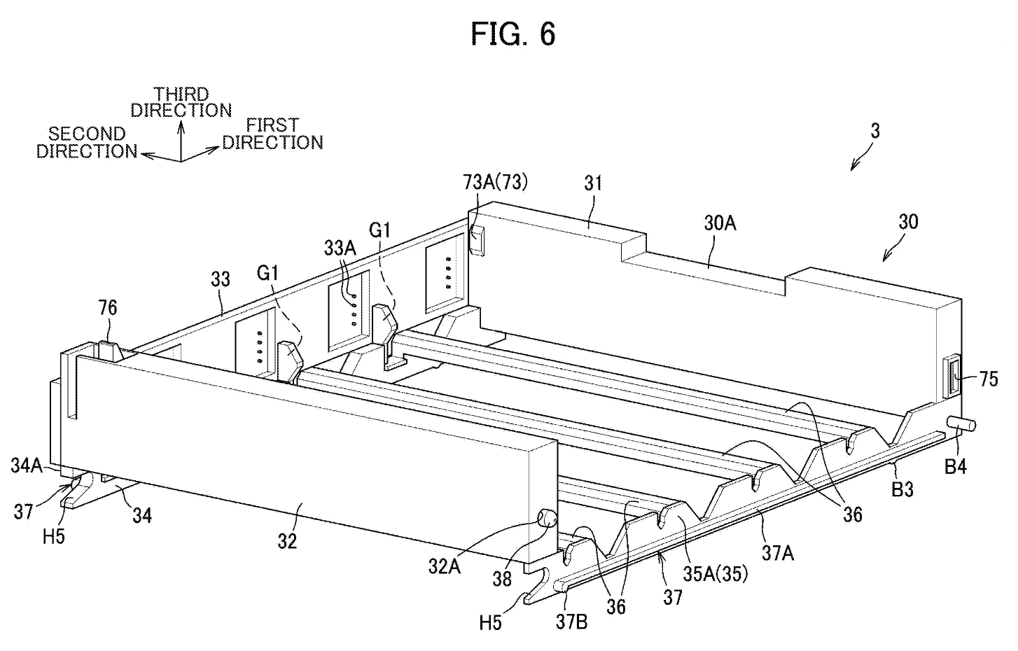

As illustrated in FIG. 6, the drawer frame 30 includes a first wall 31, a second wall 32, a third wall 33, a fourth wall 34, a fifth wall 35, four beams 36, two guide rails 37, and a pressing projection 38.

The first wall 31 is positioned at the one end portion of the drawer frame 30 in the first direction. The first wall 31 extends in the second direction. The first wall 31 has the handle 30A.

The second wall 32 is located at the other end portion of the drawer frame 30 in the first direction. The second wall 32 extends in the second direction.

The third wall 33 is positioned at one end portion of the drawer frame 30 in the second direction. The third wall 33 connects one end portion of the first wall 31 in the second direction to one end portion of the second wall 32 in the second direction. The third wall 33 has a plurality of sets of terminals 33A. When the drawer 3 is in the attached position, the terminals 33A in each set are in contact with the main-body memory electrodes 85 of the corresponding cartridge 4 illustrated in FIG. 5A. When the drawer 3 is in the attached position, the main-body charging electrode 81, main-body drum electrode 82, main-body developing electrode 83, and main-body supply electrode 84 are positioned further toward the one side in the third direction relative to the third wall 33.

The fourth wall 34 is positioned at the one end portion of the drawer frame 30 in the second direction and at the other end portion of the drawer frame 30 in the third direction. The fourth wall 34 is positioned at the other end portion of the third wall 33 in the third direction. The fourth wall 34 connects one end portion of the first wall 31 in the second direction to the one end portion of the second wall 32 in the second direction. The fourth wall 34 has a side surface 34A. The side surface 34A is a surface crossing the second direction. In the present embodiment, the side surface 34A is orthogonal to the second direction. The side surface 34A faces toward the one side in the second direction.

The fifth wall 35 is positioned at the other end portion of the drawer frame 30 in the second direction and at the other end portion of the drawer frame 30 in the third direction. The fifth wall 35 connects the other end portion of the first wall 31 in the second direction to the other end portion of the second wall 32 in the second direction. The fifth wall 35 has a side surface 35A. The side surface 35A is a surface crossing the second direction. In the present embodiment, the side surface 35A is orthogonal to the second direction. The side surface 35A faces toward the other side in the second direction.

The four beams 36 connect the fourth wall 34 and the fifth wall 35 to each other. The four beams 36 are arranged at intervals in the first direction.

The two guide rails 37 are configured to be guided by the main housing 2. One of the two guide rails 37 protrudes from the side surface 34A of the fourth wall 34, and a remaining one of the two guide rails 37 protrudes from the side surface 35A of the fifth wall 35. Each guide rail 37 extends in the first direction.

Each guide rail 37 has a base portion 37A and a protruding portion 37B. The base portion 37A extends in the first direction. The protruding portion 37B is positioned at the other end portion of the base portion 37A in the first direction. The protruding portion 37B is convex (protrudes) toward the other side in the third direction. The protruding portion 37B has a curved shape in a side view.

The pressing projection 38 is a protrusion for pressing the drawer 3 toward the one side in the second direction, i.e., toward the one end portion of the main housing 2 in the second direction. The pressing projection 38 is positioned at the other end portion of the drawer frame 30 in the first direction and at the other end portion of the drawer frame 30 in the second direction. Specifically, the pressing projection 38 is positioned at the other end portion of the second wall 32 in the second direction.

The pressing projection 38 extends in the second direction. The pressing projection 38 is movable in the second direction relative to the second wall 32. The second wall 32 has a hole 32A in which the pressing projection 38 is inserted. Although not illustrated in the drawings, a spring is arranged between the bottom of the hole 32A and the pressing projection 38.

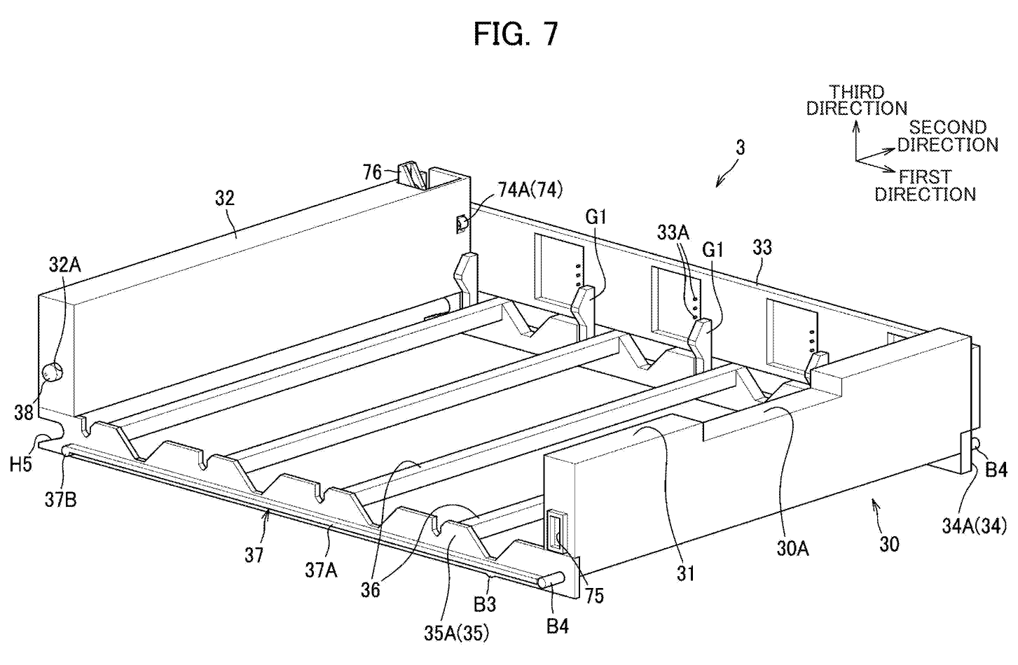

The drawer 3 further includes a first drawer electrode 73, a second drawer electrode 74 (see FIG. 7), a connector 75, and a pressing lever 76. The first drawer electrode 73 and the second drawer electrode 74 are made of sheet metal. The connector 75 includes a terminal made of metal, and a resin cover that houses the terminal. The pressing lever 76 is an electrically conductive member made of conductive resin, for example.

The first drawer electrode 73 is an electrode electrically connectable to the first main-body contact 71A (illustrated in FIG. 4) via the connector 75. The first drawer electrode 73 is positioned at the one end portion of the drawer frame 30 in the first direction and at the one end portion of the drawer frame 30 in the second direction. Specifically, the first drawer electrode 73 is positioned at one end portion of the first wall 31 in the second direction. The first drawer electrode 73 has a part accommodated inside the first wall 31, and another part exposed from a surface of the first wall 31 facing the second wall 32. The exposed part of the first drawer electrode 73 includes a first drawer contact 73A.

The connector 75 is a member configured to receive power from the first main-body contact 71A. The connector 75 is positioned at the other end portion of the drawer frame 30 in the second direction. Specifically, the connector 75 is positioned at the other end portion of the first wall 31 in the second direction. The connector 75 is electrically connected to the first drawer electrode 73. Specifically, the connector 75 is connected to the first drawer electrode 73 via a wiring (not illustrated). The connector 75 is exposed toward the other side in the second direction. The connector 75 is configured to contact the first main-body contact 71A.

As illustrated in FIG. 7, the second drawer electrode 74 is an electrode electrically connectable to the second main-body contact 72A (illustrated in FIG. 5) through the pressing lever 76. The second drawer electrode 74 and the pressing lever 76 are positioned at the other end portion of the drawer frame 30 in the first direction and at the one end portion of the drawer frame 30 in the second direction. Specifically, the second drawer electrode 74 and the pressing lever 76 are located at the one end portion of the second wall 32 in the second direction.

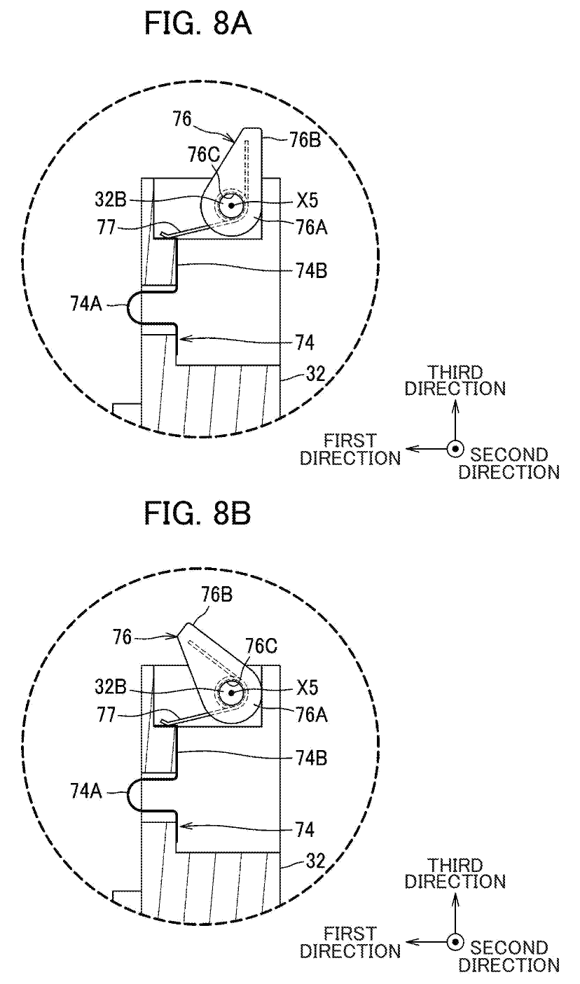

As illustrated in FIG. 8A, the second drawer electrode 74 has a part accommodated inside the second wall 32, and another part exposed from a surface of the second wall 32 facing the first wall 31. The second drawer electrode 74 includes a second drawer contact 74A and a resilient portion 74B. The second drawer contact 74A is positioned at the exposed part of the second drawer electrode 74. The second drawer contact 74A is movable in the first direction relative to the second wall 32. The resilient portion 74B urges the second drawer contact 74A toward the fourth cartridge 4D when the fourth cartridge 4D is attached to the drawer 3.

The pressing lever 76 is supported by the second wall 32 such that the pressing lever 76 is pivotable about a pivot axis X5 extending in the second direction. The pressing lever 76 is pivotable between a first lever position illustrated in FIG. 8A and a second lever position illustrated in FIG. 8B. The second wall 32 has a boss 32B extending in the second direction.

The pressing lever 76 has a base end portion 76A and a tip end portion 76B. The base end portion 76A has a hole 76C in which the boss 32B is inserted. The tip end portion 76B extends from the base end portion 76A to protrude out toward the one side in the third direction from the second wall 32.

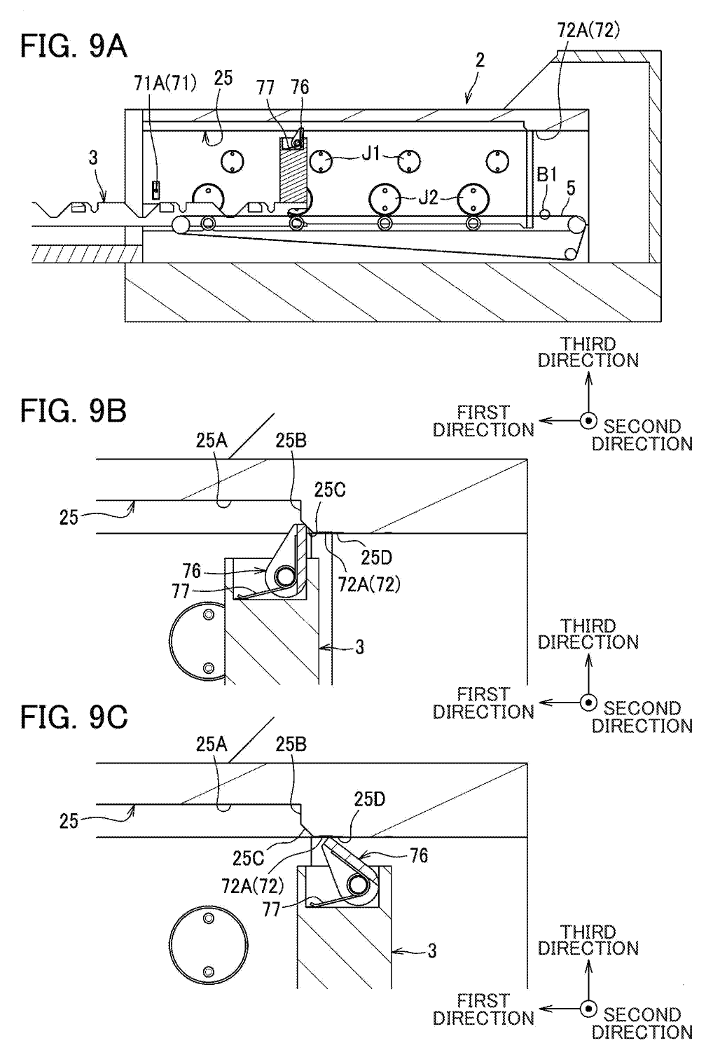

As illustrated in FIGS. 9A to 9C, when the drawer 3 is at any position between the attached position and the pulled-out position, the pressing lever 76 is received in the groove 25 of the main housing 2. As illustrated in FIGS. 9B and 9C, in a process of the drawer 3 moving from the pulled-out position to the attached position, the pressing lever 76 comes into contact with the second bottom surface 25B or the third bottom surface 25C of the groove 25, thereby pivoting from the first lever position to the second lever position. When the drawer 3 is at the attached position, the pressing lever 76 is in contact with the second main-body contact 72A and is electrically connected to the same.

As illustrated in FIG. 8B, the drawer 3 further includes a resilient member 77. The resilient member 77 is a conductive torsion spring made of metal, for example. The resilient member 77 is positioned at the other end portion of the drawer frame 30 in the first direction and at the one end portion of the drawer frame 30 in the second direction, as with the second drawer electrode 74 and the pressing lever 76. The boss 32B is received in a coil portion of the resilient member 77.

The resilient member 77 has one end portion in contact with the second drawer electrode 74, and the other end portion in contact with the pressing lever 76. Hence, the resilient member 77 is electrically connected to both the second drawer electrode 74 and the pressing lever 76. The pressing lever 76 is thus electrically connected to the second drawer electrode 74 via the resilient member 77. The resilient member 77 is electrically connectable to the second main-body electrode 72 through the pressing lever 76.

The resilient member 77 is deformable between a first state illustrated in FIG. 8A and a second state illustrated in FIG. 8B. The resilient member 77 provides a larger resilient force in the second state than in the first state.

As illustrated in FIGS. 9B and 9C, the resilient member 77 deforms from the first state to the second state by a force applied from the main housing 2, while the drawer 3 moves from the pulled-out position to the attached position. By deforming from the first state to the second state, the resilient member 77 applies pressure to the main housing 2, through the pressing lever 76, toward the one side in the third direction such that the drawer 3 is pressed toward the other side in the third direction by the resilient force of the resilient member 77.

When the drawer 3 is in the attached position, the resilient member 77 presses the pressing lever 76 against the fourth bottom surface 25D of the groove 25. Specifically, when the drawer 3 is in the attached position, the resilient member 77 urges the pressing lever 76 against the second main-body contact 72A.

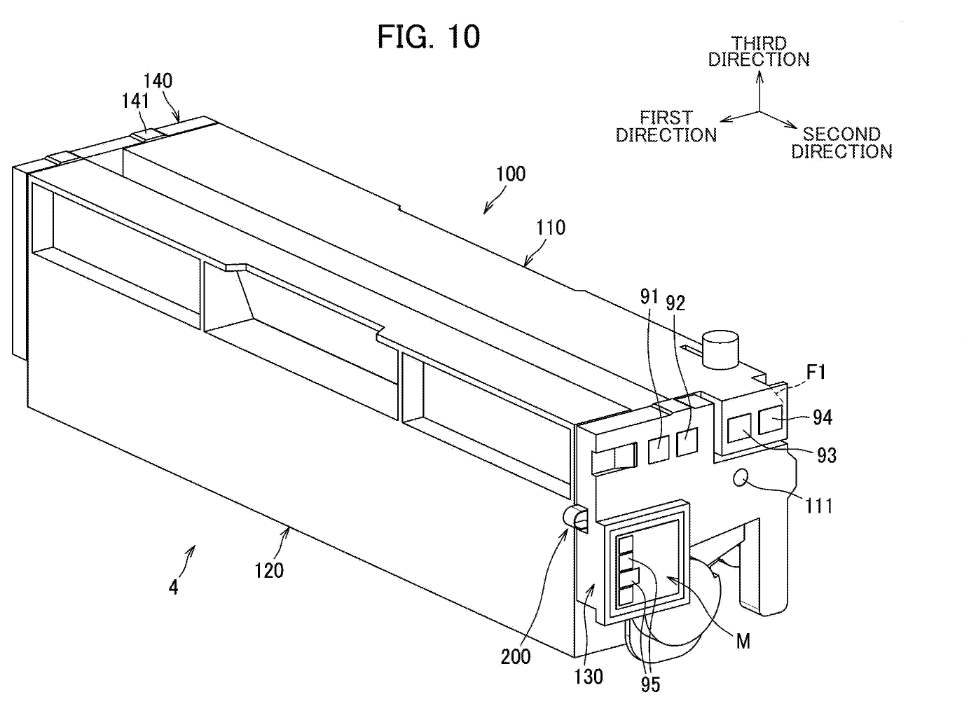

As illustrated in FIG. 10, each cartridge 4 further includes a charging electrode 91, a drum electrode 92, a developing electrode 93, a supply electrode 94, the cartridge memory M, and a cartridge electrode 200. The charging electrode 91, the drum electrode 92, the developing electrode 93, the supply electrode 94, the cartridge memory M, and the cartridge electrode 200 are positioned at one end portion of the cartridge frame 100 in the second direction.

The charging electrode 91 is electrically connected to the charging roller 42. The charging electrode 91 is connected to the charging roller 42 via a wiring (not illustrated). When the drawer 3 is in the attached position, the charging electrode 91 is in contact with the corresponding main-body charging electrode 81.

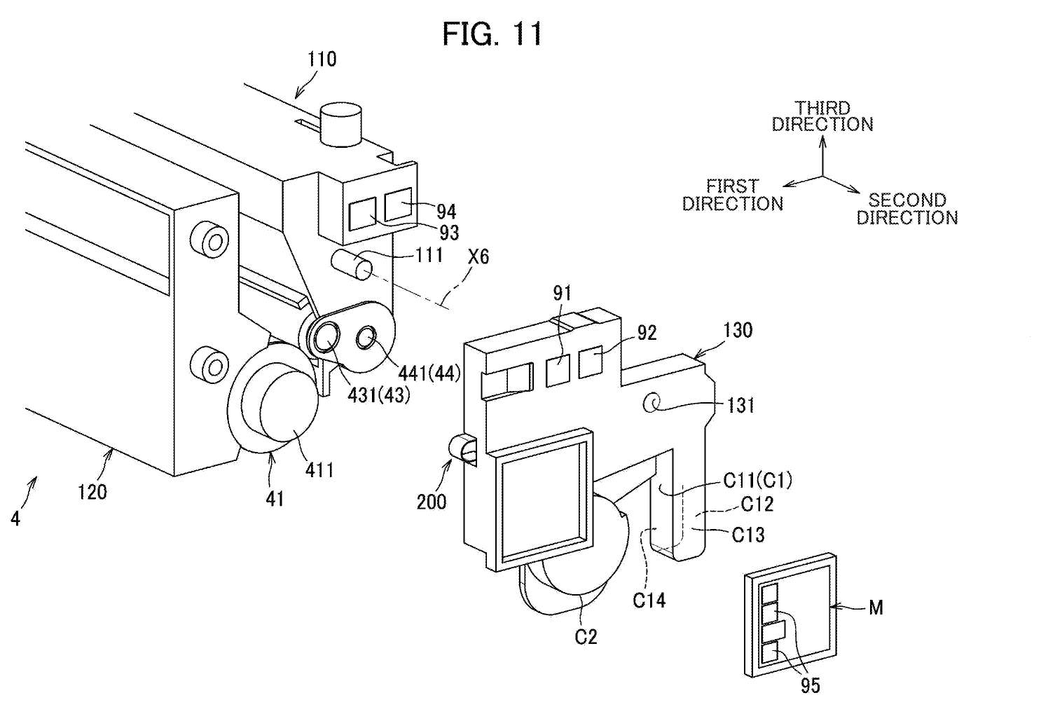

As illustrated in FIG. 11, the photosensitive drum 41 includes a drum shaft 411 extending in the second direction. The developing roller 43 includes a developing shaft 431 extending in the second direction. The supply roller 44 includes a supply shaft 441 extending in the second direction.

The drum electrode 92 is electrically connected to the drum shaft 411. The drum electrode 92 is connected to the drum shaft 411 via a wiring (not illustrated). When the drawer 3 is in the attached position, the drum electrode 92 is in contact with the corresponding main-body drum electrode 82.

The developing electrode 93 is electrically connected to the developing shaft 431. The developing electrode 93 is connected to the developing shaft 431 via a wiring (not illustrated). When the drawer 3 is in the attached position, the developing electrode 93 is in contact with the corresponding main-body developing electrode 83.

The supply electrode 94 is electrically connected to the supply shaft 441. The supply electrode 94 is connected to the supply shaft 441 via a wiring (not illustrated). When the drawer 3 is in the attached position, the supply electrode 94 is in contact with the corresponding main-body supply electrode 84.

The cartridge memory M includes a plurality of memory electrodes 95. When the drawer 3 is in the attached position, the memory electrodes 95 are in contact with the corresponding terminals 33A of the drawer 3. As a result, the memory electrodes 95 are electrically connected to the corresponding main-body memory electrodes 85 via the terminals 33A of the drawer 3.

The cartridge electrode 200 is an electrode for relaying the first drawer electrode 73 and the second drawer electrode 74. A structure of the cartridge electrode 200 will be described in detail later.

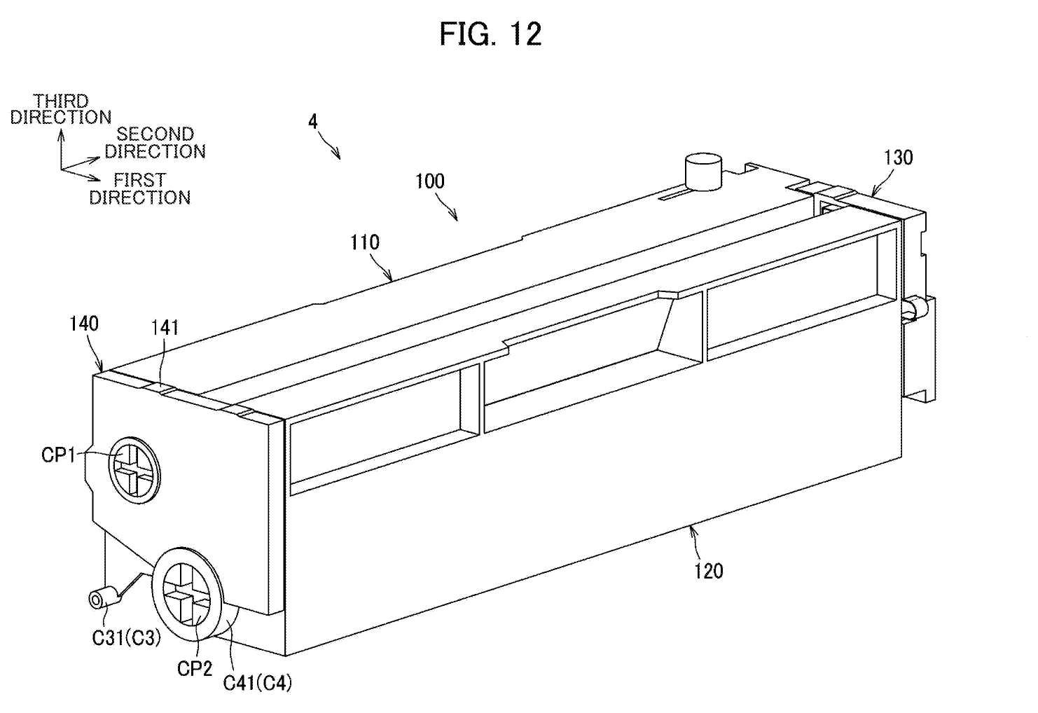

As illustrated in FIG. 12, each cartridge 4 further includes a developing coupling CP1 and a drum coupling CP2. The developing coupling CP1 and the drum coupling CP2 are located at the other end portion of the corresponding cartridge 4 in the second direction.

The developing coupling CP1 is a member configured to transmit the driving force received from the corresponding developing joint J1 to the corresponding developing roller 43. Each developing joint J1 can be inserted into and removed from the corresponding developing coupling CP1.

The drum coupling CP2 is a member configured to transmit the driving force received from the corresponding drum joint J2 to the corresponding photosensitive drum 41. Each drum joint J2 can be inserted into and removed from the corresponding drum coupling CP2. The drum coupling CP2 is positioned apart from the developing coupling CP1. Relative to the developing coupling CP1, the drum coupling CP2 is positioned further toward the other side in the third direction and toward the one side in the first direction.

The cartridge frame 100 includes a developing frame 110, a drum frame 120, a side cover 130, and a cover 140. The side cover 130 is positioned at one end portion of the cartridge frame 100 in the second direction. The cover 140 is positioned at the other end portion of the cartridge frame 100 in the second direction.

In other words, the side cover 130 is positioned at one end portion of the developing roller 43 in the second direction. The cover 140 is positioned at the other end portion of the developing roller 43 in the second direction.

As illustrated in FIG. 11, the developing frame 110 rotatably supports the developing shaft 431 of the developing roller 43. The developing frame 110 is positioned further toward the other side in the first direction relative to the drum frame 120. The developing frame 110 is pivotable, relative to the drum frame 120, about a pivot axis X6 extending in the second direction. Specifically, the developing frame 110 is pivotable between a contact position where the developing roller 43 is in contact with the photosensitive drum 41 and a separation position where the developing roller 43 is separated from the photosensitive drum 41.

The developing frame 110 has a cylindrical boss 111 centered on the pivot axis X6. The developing electrode 93 and the supply electrode 94 are positioned at one end portion of the developing frame 110 in the second direction.

The drum frame 120 rotatably supports the drum shaft 411 of the photosensitive drum 41 through the side cover 130. Alternatively, the drum frame 120 may directly support the drum shaft 411.

The side cover 130 holds the one end portion of the developing frame 110 in the second direction and one end portion of the drum frame 120 in the second direction. Specifically, the side cover 130 is fixed to the one end portion of the drum frame 120 in the second direction. The side cover 130 has a hole 131 in which the boss 111 of the developing frame 110 is inserted. The side cover 130 supports the developing frame 110 such that the developing frame 110 is pivotable relative to the side cover 130 and the drum frame 120. The charging electrode 91, the drum electrode 92, the cartridge memory M, and the cartridge electrode 200 are positioned on the side cover 130.

As illustrated in FIG. 12, the cover 140 holds the other end portion of the developing frame 110 in the second direction and the other end portion of the drum frame 120 in the second direction. Specifically, the cover 140 is fixed to the other end portion of the drum frame 120 in the second direction. The cover 140 supports the developing frame 110 such that the developing frame 110 is pivotable relative to the cover 140 and the drum frame 120.

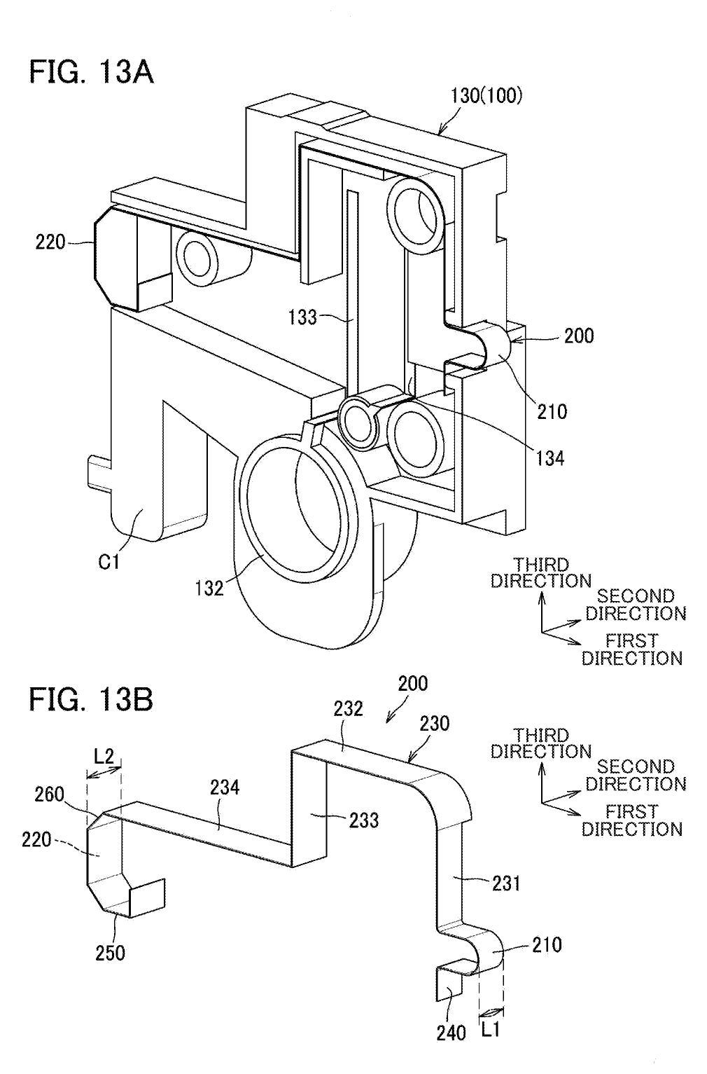

The cartridge electrode 200 is an electrode configured to be electrically connected to the first drawer electrode 73 and the second drawer electrode 74. As illustrated in FIGS. 13A and 13B, the cartridge electrode 200 has a one-side contact 210, an other-side contact 220, an electrode body 230, a one-side engaging portion 240, and an other-side engaging portion 250.

The one-side contact 210 is a portion configured to contact a corresponding external electrode located on the one side of the cartridge electrode 200 in the first direction. The one-side contact 210 has a curved surface that is convex toward the one side in the first direction.

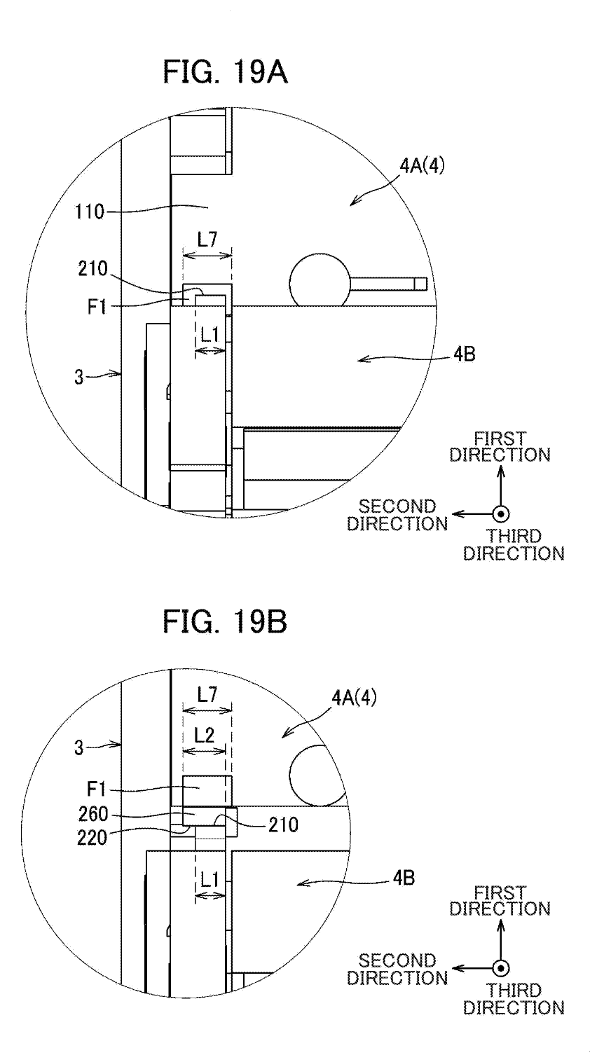

The one-side contact 210 is positioned at the one end portion of the cartridge frame 100 in the first direction. Specifically, the one-side contact 210 is positioned at one end portion of the side cover 130 in the first direction. The one-side contact 210 is exposed from a surface of the side cover 130 at the one side in the first direction. The one-side contact 210 is movable in the first direction relative to the side cover 130. The one-side contact 210 has a length L1 in the second direction that is shorter than a length L2 in the second direction of the other-side contact 220 (see also FIG. 19B).

The other-side contact 220 is a portion configured to contact a corresponding external electrode located on the other side of the cartridge electrode 200 in the first direction. The other-side contact 220 has a flat plane that is orthogonal to the first direction.

The other-side contact 220 is positioned at the other end portion of the cartridge frame 100 in the first direction. Specifically, the other-side contact 220 is positioned at the other end portion of the side cover 130 in the first direction. The other-side contact 220 is exposed from a surface of the side cover 130 at the other side in the first direction.

The electrode body 230 extends from the one-side contact 210 to the other-side contact 220. The electrode body 230 has a resilient part 231, a first part 232, a second part 233, and a third part 234. The resilient part 231 has the same length in the second direction as the one-side contact 210 and the one-side engaging portion 240. The first part 232, the second part 233, the third part 234, the other-side contact 220, and the other-side engaging portion 250 have the same length as each other in the second direction.

The resilient part 231 extends, from one end portion of the one-side contact 210 in the third direction, toward the other side in the first direction, and then extends toward the one side in the third direction. The resilient part 231 is resiliently deformable in the first direction. The resilient part 231 urges the one-side contact 210 toward a corresponding external electrode located on the one side of the cartridge electrode 200 in the first direction.

The first part 232 extends, from one end portion of the resilient part 231 in the third direction, toward the other side in the first direction while making a curve, and then extends toward the other side in the first direction. The second part 233 extends, from the other end portion of the first part 232 in the first direction, toward the other side in the third direction. The third part 234 extends, from the other end portion of the second part 233 in the third direction, toward the other side in the first direction. The third part 234 then extends diagonally toward the other side in the first direction and toward the other side in the third direction, and is connected to the other-side contact 220.

The third part 234 has an inclined surface 260. The inclined surface 260 is inclined relative to the first direction. The inclined surface 260 is positioned at the other end portion of the cartridge frame 100 in the first direction. Specifically, the inclined surface 260 is positioned at the other end portion of the side cover 130 in the first direction.

As illustrated in FIGS. 13B and 19B, the inclined surface 260 has the length L2 in the second direction (the same length as the other-side contact 220) that is longer than the length L1 in the second direction of the one-side contact 210. With respect to the position in the second direction, the inclined surface 260 is at the same position as the other-side contact 220. The inclined surface 260 is positioned further toward the one side in the third direction relative to the other-side contact 220. In other words, the inclined surface 260 is positioned upstream, relative to the other-side contact 220, in an attaching direction of the cartridge 4 to the drawer 3.

The one-side engaging portion 240 is a portion that hooks on the one end portion of the side cover 130 in the first direction. As illustrated in FIGS. 13A and 13B, the one-side engaging portion 240 extends, from the other end portion of the one-side contact 210 in the third direction, toward the other side in the first direction and then extends toward the other side in the third direction.

The other-side engaging portion 250 is a portion hooked on the other end portion of the side cover 130 in the first direction. The other-side engaging portion 250 extends diagonally, from the other end portion of the other-side contact 220 in the third direction, toward the one side in the first direction and toward the other side in the third direction, then extends toward the one side in the first direction, and subsequently extends toward the one side in the third direction.

As illustrated in FIG. 13A, the side cover 130 further includes a drum bearing 132, a drum wiring 133, and a charging wiring 134.

The drum bearing 132 is electrically conductive. The drum wiring 133 connects the drum bearing 132 to the drum electrode 92. The charging wiring 134 connects the charging roller 42 to the charging electrode 91.

The cartridge electrode 200 is so shaped that the cartridge electrode 200 bypasses the drum wiring 133 and the charging wiring 134 so as not to be electrically connected to the photosensitive drum 41 and the charging roller 42. In other words, the drum wiring 133 and the charging wiring 134 are disposed inside a U-shaped portion of the cartridge electrode 200 defined by the resilient part 231, the first part 232, and the second part 233.

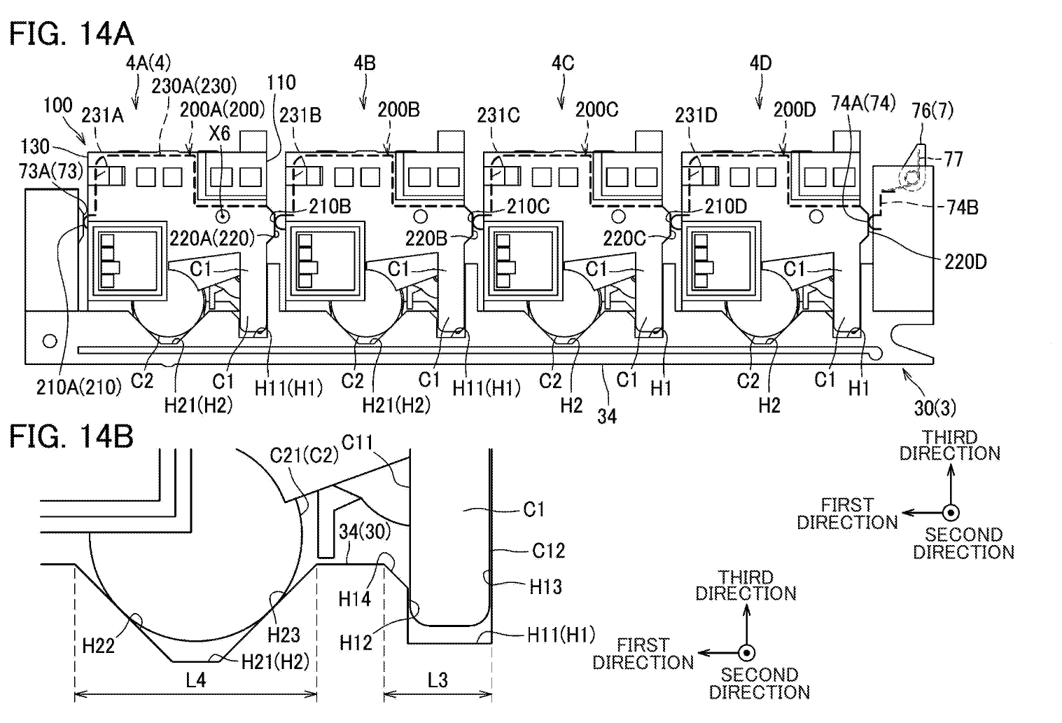

As illustrated in FIG. 14A, the first cartridge 4A includes a first cartridge electrode 200A. The second cartridge 4B includes a second cartridge electrode 200B. The third cartridge 4C includes a third cartridge electrode 200C. The fourth cartridge 4D includes a fourth cartridge electrode 200D.

Hereinafter, contact states of the respective electrodes in a state where all the four cartridges 4 are attached to the drawer 3 will be described in detail.

The first drawer contact 73A of the first drawer electrode 73 is in contact with a first one-side contact 210A (the one-side contact 210 of the first cartridge electrode 200A of the first cartridge 4A). A first other-side contact 220A (the other-side contact 220 of the first cartridge electrode 200A of the first cartridge 4A) is in contact with a second one-side contact 210B (the one-side contact 210 of the second cartridge electrode 200B of the second cartridge 4B). A second other-side contact 220B (the other-side contact 220 of the second cartridge electrode 200B of the second cartridge 4B) is in contact with a third one-side contact 210C (the one-side contact 210 of the third cartridge electrode 200C of the third cartridge 4C). A third other-side contact 220C (the other-side contact 220 of the third cartridge electrode 200C of the third cartridge 4C) is in contact with a fourth one-side contact 210D (the one-side contact 210 of the fourth cartridge electrode 200D of the fourth cartridge 4D). A fourth other-side contact 220D (the other-side contact 220 of the fourth cartridge electrode 200D of the fourth cartridge 4D) is in contact with the second drawer contact 74A of the second drawer electrode 74.

Hence, the first drawer contact 73A of the first drawer electrode 73 is electrically connected to the first one-side contact 210A. The first other-side contact 220A is electrically connected to the second one-side contact 210B. The second other-side contact 220B is electrically connected to the second drawer contact 74A of the second drawer electrode 74 through the third cartridge electrode 200C and the fourth cartridge electrode 200D. The resilient member 77 is thus electrically connected to the respective cartridge electrodes 200 (200A-200D) through the second drawer electrode 74.

Further, a first resilient part 231A (resilient part 231) of the first cartridge electrode 200A urges the first one-side contact 210A against the first drawer electrode 73. A second resilient part 231B (resilient part 231) of the second cartridge electrode 200B urges the second one-side contact 210B against the first other-side contact 220A. The second resilient part 231B also urges the first cartridge 4A toward the one side in the first direction.

A third resilient part 231C (resilient part 231) of the third cartridge electrode 200C urges the third one-side contact 210C against the second other-side contact 220B. The third resilient part 231C also urges the second cartridge 4B toward the one side in the first direction.

A fourth resilient part 231D (resilient part 231) of the fourth cartridge electrode 200D urges the fourth one-side contact 210D against the third other-side contact 220C. The fourth resilient part 231D also urges the third cartridge 4C toward the one side in the first direction.

The resilient portion 74B of the second drawer electrode 74 urges the second drawer contact 74A against the fourth other-side contact 220D. The resilient portion 74B of the second drawer electrode 74 also urges the fourth cartridge 4D toward the one side in the first direction.

The first drawer electrode 73, each of the cartridge electrodes 200, the second drawer electrode 74, the resilient member 77, and the pressing lever 76 are electrically connected to each other when all the cartridges 4 are attached to the drawer 3. In a state where the drawer 3 having all the four cartridges 4 attached thereto is in the attached position relative to the main housing 2, a single electrical circuit 7 is formed between the first main-body electrode 71 illustrated in FIG. 4 and the second main-body electrode 72 illustrated in FIG. 5 via the connector 75 illustrated in FIG. 6, the first drawer electrode 73, each of the cartridge electrodes 200, the second drawer electrode 74, the resilient member 77, and the pressing lever 76.

The controller 6 has a function to determine whether all the cartridges 4 are attached to the drawer 3 based on an electrical conduction state of the electrical circuit 7. Specifically, the controller 6 is configured to make this determination by applying a voltage to the electrical circuit 7 and detecting, using a sensor, whether a current flows between the first main-body electrode 71 and the second main-body electrode 72. When the controller 6 detects that the current flows between the first main-body electrode 71 and the second main-body electrode 72 based on information from the sensor, the controller 6 determines that all of the cartridges 4 have been attached to the drawer 3. Conversely, if the controller 6 does not detect that the current flows between the first main-body electrode 71 and the second main-body electrode 72 based on the information from the sensor, the controller 6 determines that at least one cartridge 4 has not yet been attached to the drawer 3.

As illustrated in FIGS. 14B and 11, the side cover 130 includes a first protrusion C1 and a second protrusion C2.

The first protrusion C1 is a column having a rectangular cross-sectional shape when taken along a plane perpendicular to the third direction. The first protrusion C1 protrudes toward the other side in the third direction. The first protrusion C1 has a first surface C11, a second surface C12, a third surface C13, and a fourth surface C14.

The first surface C11 and the second surface C12 are surfaces that are orthogonal to the first direction. The first surface C11 is positioned at one end portion of the first protrusion C1 in the first direction. The second surface C12 is positioned at the other end portion of the first protrusion C1 in the first direction.

The third surface C13 and the fourth surface C14 are surfaces that are orthogonal to the second direction. The third surface C13 and the fourth surface C14 connect the first surface C11 to the second surface C12. The third surface C13 is positioned at one end portion of the first protrusion C1 in the second direction. The fourth surface C14 is positioned at the other end portion of the first protrusion C1 in the second direction.

The first protrusion C1 has a length in the third direction that is longer than a diameter of the developing roller 43. The length in the third direction of the first protrusion C1 is also longer than a diameter of the photosensitive drum 41. As illustrated in FIG. 14A, in each cartridge 4, the first protrusion C1 is positioned between the one-side contact 210 and the other-side contact 220 in the first direction.

As illustrated in FIG. 14B, the second protrusion C2 protrudes toward the other side in the third direction. The second protrusion C2 has the above-described drum bearing 132 illustrated in FIG. 13. The second protrusion C2 has a cylindrical peripheral surface C21 centered on an axis extending in the second direction. The second protrusion C2 is positioned further toward the one side in the first direction relative to the first protrusion C1.

The fourth wall 34 of the drawer frame 30 has four sets of a first recess H1 and a second recess H2. The first recess H1 and the second recess H2 in each set are spaced apart from each other in the first direction.

Each first recess H1 is recessed toward the other side in the third direction. The first protrusion C1 of each side cover 130 is configured to be received in the corresponding first recess H1. Each first recess H1 has a bottom surface H11, a first surface H12, a second surface H13, and an inclined surface H14. The bottom surface H11, the first surface H12, the second surface H13, and the inclined surface H14 are all flat surfaces.

The bottom surface H11 is positioned at the other end portion of the first recess H1 in the third direction. The first surface H12 extends toward the one side in the third direction from one end portion of the bottom surface H11 in the first direction. The second surface H13 extends toward the one side in the third direction from the other end portion of the bottom surface H11 in the first direction.

The inclined surface H14 is a surface for guiding the corresponding first protrusion C1 toward the bottom surface H11. The inclined surface H14 is inclined relative to the first direction. The inclined surface H14 extends, from one end portion of the first surface H12 in the third direction, diagonally toward the one side in the first direction and toward the one side in the third direction.

The first surface H12 of the first recess H1 is configured to contact the first surface C11 of the corresponding first protrusion C1. The second surface H13 of the first recess H1 is configured to contact the second surface C12 of the corresponding first protrusion C1. In a state where the cartridges 4 are attached to the drawer 3, the first protrusion C1 is spaced apart from the bottom surface H11 of the corresponding first recess H1 in the third direction.

Each second recess H2 is recessed toward the other side in the third direction. The second protrusion C2 of each side cover 130 is configured to be received in the corresponding second recess H2. Each second recess H2 has a bottom surface H21, a first surface H22, and a second surface H23.

The bottom surface H21 is positioned at the other end portion of the second recess H2 in the third direction. The first surface H22 extends, from one end portion of the bottom surface H21 in the first direction, diagonally toward the one side in the third direction and toward the one side in the first direction. The first surface H22 is inclined relative to the first direction. The second surface H23 extends, from the other end portion of the bottom surface H21 in the first direction, diagonally toward the one side in the third direction and toward the other side in the first direction. The second surface H23 is inclined relative to the first direction.

In the state where the cartridges 4 are attached to the drawer 3, both the first surface H22 and the second surface H23 are in contact with the cylindrical peripheral surface C21 of the corresponding second protrusion C2. In the state where the cartridges 4 are attached to the drawer 3, the second protrusion C2 is spaced apart from the bottom surface H21 of the corresponding second recess H2 in the third direction.

The first recess H1 has a length L3 in the first direction that is shorter than a length L4 in the first direction of the second recess H2. As illustrated in FIG. 14A, in each cartridge 4, the pivot axis X6 of the developing frame 110 is positioned between the first recess H1 and the second recess H2 in the first direction. In the third direction, the bottom surface H11 of the first recess H1 is positioned closer to the pivot axis X6 than the bottom surface H21 of the second recess H2 is to the pivot axis X6 in each cartridge 4.

The first recesses H1 are arranged at positions corresponding to the first protrusions C1 of the respective cartridges 4. The second recesses H2 are arranged at positions corresponding to the second protrusions C2 of the respective cartridges 4. That is, the fourth wall 34 of the drawer frame 30 includes four of the first recesses H1 and four of the second recesses H2.

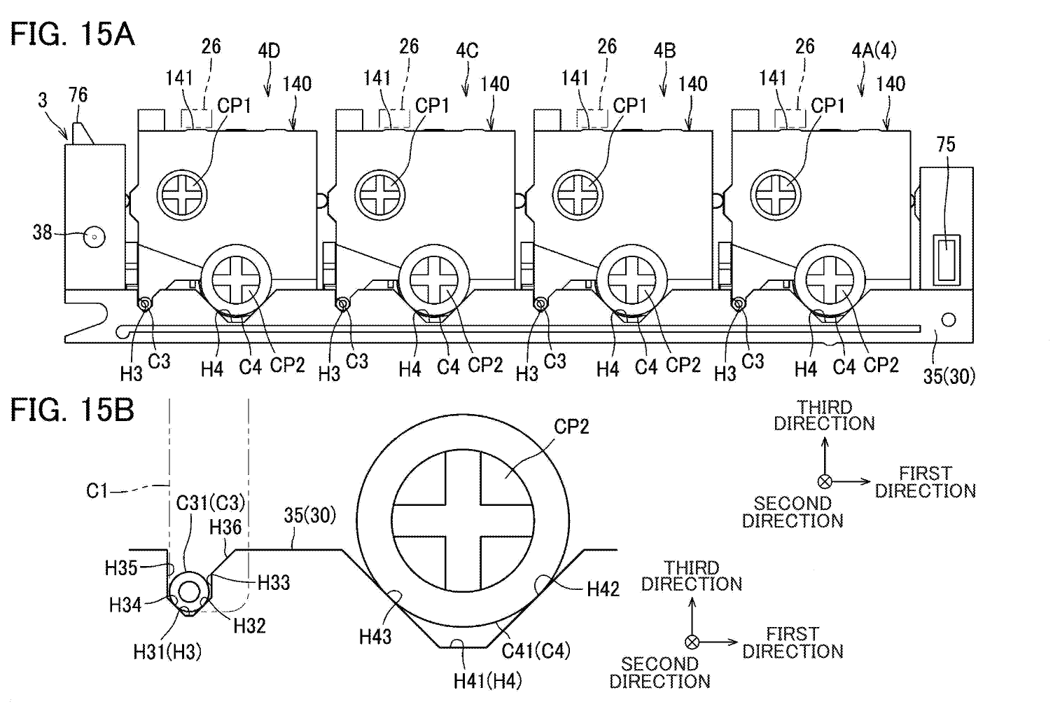

As illustrated in FIGS. 15B and 12, each cover 140 includes a third protrusion C3 and a fourth protrusion C4.

The third protrusion C3 protrudes toward the other side in the second direction. The third protrusion C3 has a cylindrical peripheral surface C31 centered on an axis extending in the second direction. The cylindrical peripheral surface C31 extends in the second direction.

The fourth protrusion C4 protrudes toward the other side in the third direction. The fourth protrusion C4 has a cylindrical peripheral surface C41 centered on an axis extending in the second direction. The fourth protrusion C4 rotatably supports the drum coupling CP2. When projected in the second direction, the cylindrical peripheral surface C41 coincides with the cylindrical peripheral surface C21 of the second protrusion C2 in each cartridge 4. In other words, the center of the cylindrical peripheral surface C41 is coincident with the center of the cylindrical peripheral surface C21, and the cylindrical peripheral surface C41 has the same radius as the cylindrical peripheral surface C21.

As illustrated in FIGS. 15A and 15B, the fifth wall 35 of the drawer frame 30 has four sets of a third recess H3 and a fourth recess H4. The third recess H3 and the fourth recess H4 in each set are spaced apart from each other in the first direction.

Each third recess H3 is recessed toward the other side in the third direction. The third protrusion C3 of each cover 140 is configured to be received in the corresponding third recess H3. Each third recess H3 has a bottom surface H31, a first surface H32, a second surface H33, a third surface H34, a fourth surface H35, and an inclined surface H36.

The bottom surface H31 is positioned at the other end portion of the third recess H3 in the third direction. The first surface H32 extends, from one end portion of the bottom surface H31 in the first direction, diagonally toward the one side in the third direction and toward the one side in the first direction. The first surface H32 is inclined relative to the first direction. The second surface H33 extends, from one end portion of the first surface H32 in the first direction, toward the one side in the third direction.

The third surface H34 extends, from the other end portion of the bottom surface H31 in the first direction, diagonally toward the one side in the third direction and toward the other side in the first direction. The third surface H34 is inclined relative to the first direction. The fourth surface H35 extends toward the one side in the third direction from the other end portion of the third surface H34 in the first direction.

The inclined surface H36 is a surface for guiding the corresponding third protrusion C3 toward the bottom surface H31. The inclined surface H36 extends, from one end portion of the second surface H33 in the third direction, diagonally toward the one side in the first direction and toward the one side in the third direction. The inclined surface H36 is inclined relative to the first direction.

In the state where the cartridges 4 are attached to the drawer 3, the cylindrical peripheral surface C31 of each third protrusion C3 is in contact with the corresponding third recess H3. Specifically, the cylindrical peripheral surface C31 of each third protrusion C3 is in contact with the first surface H32 and the third surface H34 of the corresponding third recess H3 in the state where the cartridges 4 are attached to the drawer 3.

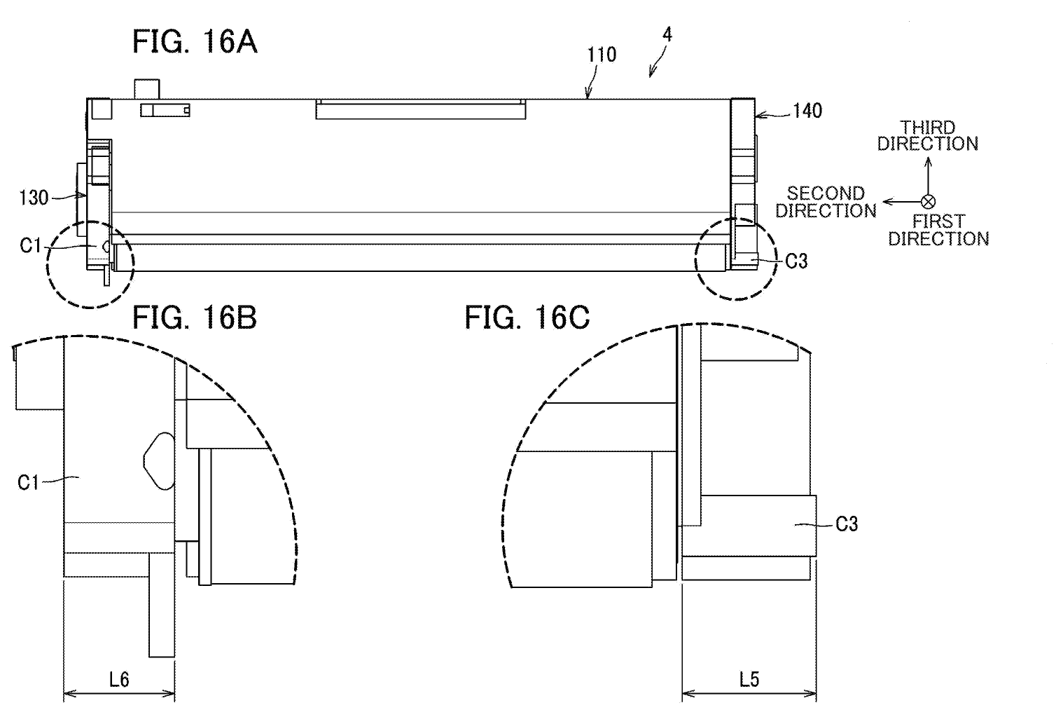

With respect to the position in the first direction, a portion of the first protrusion C1 and a portion of the third protrusion C3 are at the same position as each other. As illustrated in FIGS. 16A to 16C, in each cartridge 4, the third protrusion C3 has a length L5 in the second direction that is longer than a length L6 in the second direction of the first protrusion C1.

As illustrated in FIG. 15B, each fourth recess H4 is recessed toward the other side in the third direction. The fourth protrusion C4 of each cover 140 is configured to be received in the corresponding fourth recess H4. Each fourth recess H4 has a bottom surface H41, a first surface H42, and a second surface H43.

The bottom surface H41 is positioned at the other end portion of the fourth recess H4 in the third direction. The first surface H42 extends, from one end portion of the bottom surface H41 in the first direction, diagonally toward the one side in the third direction and toward the one side in the first direction. The first surface H42 is inclined relative to the first direction. The second surface H43 extends, from the other end portion of the bottom surface H41 in the first direction, diagonally toward the one side in the third direction and toward the other side in the first direction. The second surface H43 is inclined relative to the first direction.

In the state where the cartridges 4 are attached to the drawer 3, the first surface H42 and second surface H43 of each fourth recess H4 are in contact with the cylindrical peripheral surface C41 of the corresponding fourth protrusion C4. In the state where the cartridges 4 are attached to the drawer 3, each fourth protrusion C4 is spaced apart from the bottom surface H41 of the corresponding fourth recess H4 in the third direction.

Each second recess H2 and each fourth recess H4 function to provide positioning of the corresponding cartridge 4 in the first direction and the third direction. Each first recess H1 and each third recess H3 function to restrict the corresponding cartridge 4 supported by the corresponding second recess H2 and fourth recess H4 from pivoting about the axis of the cylindrical peripheral surface C41 of the fourth protrusion C4, thereby providing positioning of the corresponding cartridge 4.

As illustrated in FIG. 15A, the third recesses H3 are arranged at positions corresponding to the third protrusions C3 of the respective cartridges 4. The fourth recesses H4 are arranged at positions corresponding to the fourth protrusions C4 of the respective cartridges 4. In other words, the fifth wall 35 of the drawer frame 30 has four of the third recesses H3 and four of the fourth recesses H4.

In the state where the cartridges 4 are attached to the drawer 3, the pressing projection 38 of the drawer 3 is arranged at a different position from the developing coupling CP1 and the drum coupling CP2 of each cartridge 4 in the third direction. Specifically, in the state where the cartridges 4 are attached to the drawer 3, the pressing projection 38 is positioned between the developing coupling CP1 and the drum coupling CP2 of each cartridge 4 in the third direction.

The main housing 2 includes cartridge pressing parts 26 each configured to press the corresponding cartridge 4 toward the other side in the third direction (see FIG. 15A). The cartridge pressing parts 26 are arranged at positions corresponding to the respective cartridges 4 attached to the drawer 3. That is, the main housing 2 includes four cartridge pressing parts 26. Each cartridge pressing part 26 may be a spring, a mechanism including a spring, or a cam pivotable by a motor, for example.

The cover 140 of each cartridge 4 has a contact portion 141 configured to contact the corresponding cartridge pressing part 26. In the state where the cartridges 4 are attached to the drawer 3, each contact portion 141 is positioned between the corresponding third recess H3 and fourth recess H4 in the first direction. As illustrated in FIG. 12, each contact portion 141 protrudes toward the one side in the third direction.

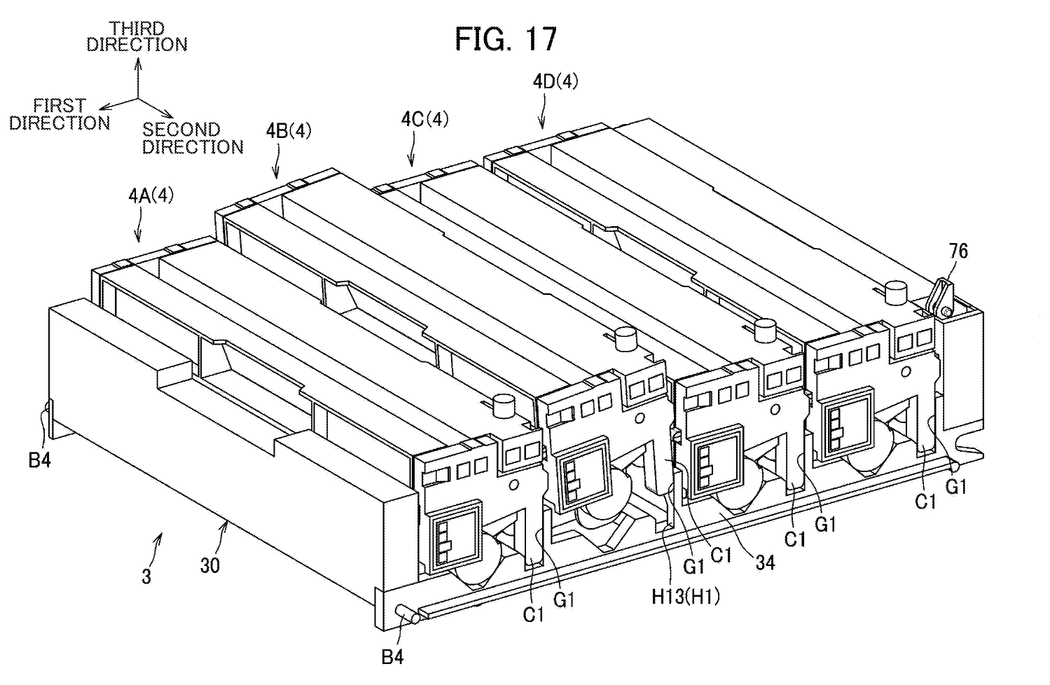

As illustrated in FIG. 17, the fourth wall 34 of the drawer frame 30 has four guide surfaces G1 (also see FIG. 6). The guide surfaces G1 are surfaces configured to guide the respective cartridges 4 in the third direction. Each guide surface G1 is configured to contact the first protrusion C1 of the corresponding cartridge 4.

Each guide surface G1 is arranged at a position corresponding to the first protrusion C1 of the corresponding cartridge 4. Specifically, each guide surface G1 is positioned at one end portion of the second surface H13 of the corresponding first recess H1 in the third direction. Each guide surface G1 and the corresponding second surface H13 are flush with each other.

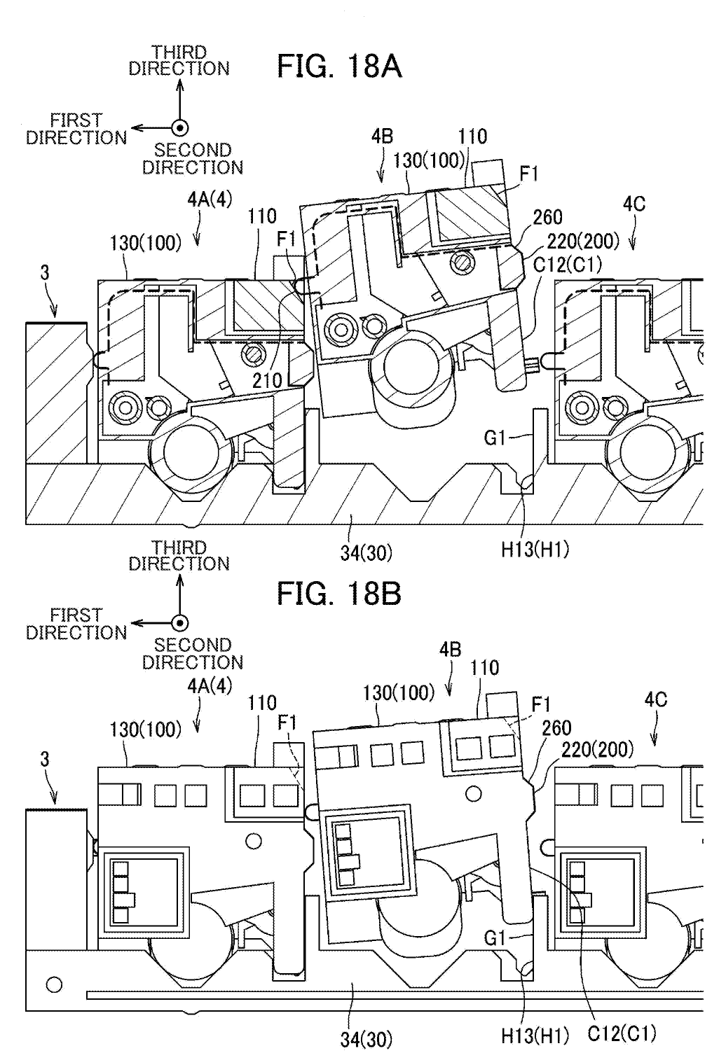

As illustrated in FIGS. 18A and 18B, the second surface C12 of each side cover 130 serves as a surface configured to be guided by the corresponding guide surface G1 while being contacted thereby. Each second surface C12 is positioned downstream of the corresponding other-side contact 220 in the attaching direction of the cartridge 4 to the drawer 3.

As illustrated in FIG. 18A, each developing frame 110 has an inclined surface F1. In the state where the cartridge 4 is attached to the drawer 3, the inclined surface F1 is inclined relative to the first direction. The inclined surface F1 is positioned at the other end portion of the cartridge frame 100 in the first direction. Specifically, the inclined surface F1 is positioned at the other end portion of the developing frame 110 in the first direction.

The inclined surface F1 is positioned further toward the one side in the third direction relative to the other-side contact 220. Specifically, the inclined surface F1 is positioned upstream of the other-side contact 220 in the attaching direction of the cartridge 4 to the drawer 3. The inclined surface F1 is positioned upstream of the inclined surface 260 of the cartridge electrode 200 in the attaching direction of the cartridge 4 to the drawer 3.

As illustrated in FIG. 19A, the inclined surface F1 has a length L7 in the second direction that is longer than the length L1 in the second direction of the one-side contact 210. As illustrated in FIG. 19B, the length L7 of the inclined surface F1 in the second direction is also longer than the length L2 of the other-side contact 220 in the second direction. With respect to the position in the second direction, a part of the inclined surface F1 is at the same position as the other-side contact 220.

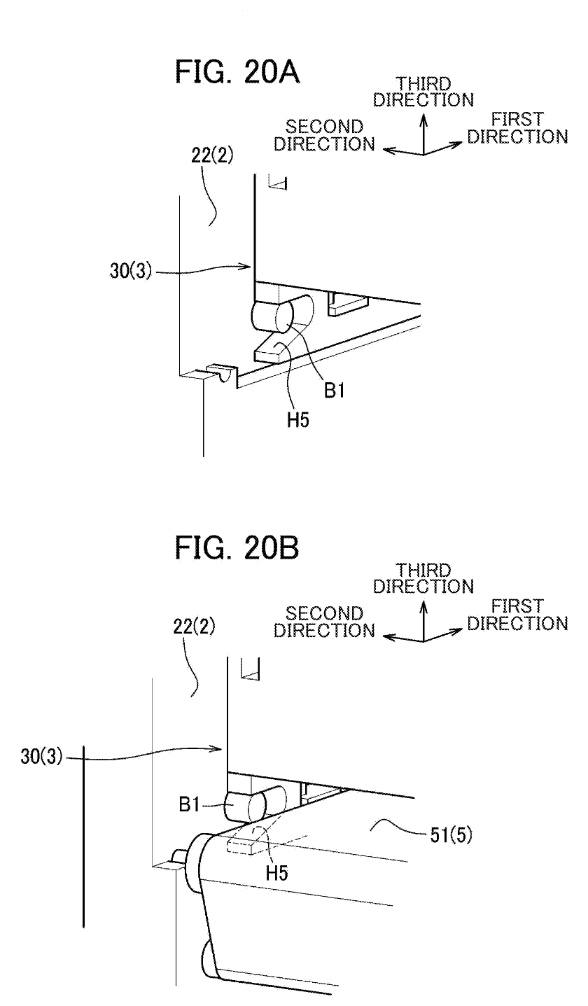

As illustrated in FIGS. 20A and 20B, the main housing 2 includes a boss B1. Specifically, the side frame 22 supporting the belt unit 5 includes the boss B1. The boss B1 extends in the second direction.

The drawer frame 30 has a recess H5. The recess H5 is positioned at the other end portion of the drawer frame 30 in the first direction (also see FIG. 7). The recess H5 is recessed toward the one side in the first direction. When the drawer 3 is in the attached position, the boss B1 is received in the recess H5.

As illustrated in FIG. 4, the main housing 2 includes two of the above-described bosses B1. Specifically, the side frame 23 at the other side in the second direction also has the boss B1 similar to the boss B1 on the side frame 22 at the one side in the second direction. The two bosses B1 are spaced apart from each other in the second direction. The two bosses are at the same position as each other with respect to the first and third directions.

As illustrated in FIG. 6, the drawer frame 30 includes two of the recesses H5. One of the recesses H5 is positioned at the other end portion of the fourth wall 34 of the drawer frame 30 in the first direction. The other recess H5 is positioned at the other end portion of the fifth wall 35 of the drawer frame 30 in the first direction. The two recesses H5 are spaced apart from each other in the second direction. When the drawer 3 is in the attached position, each boss B1 is inserted in the corresponding recess H5 of the drawer 3.

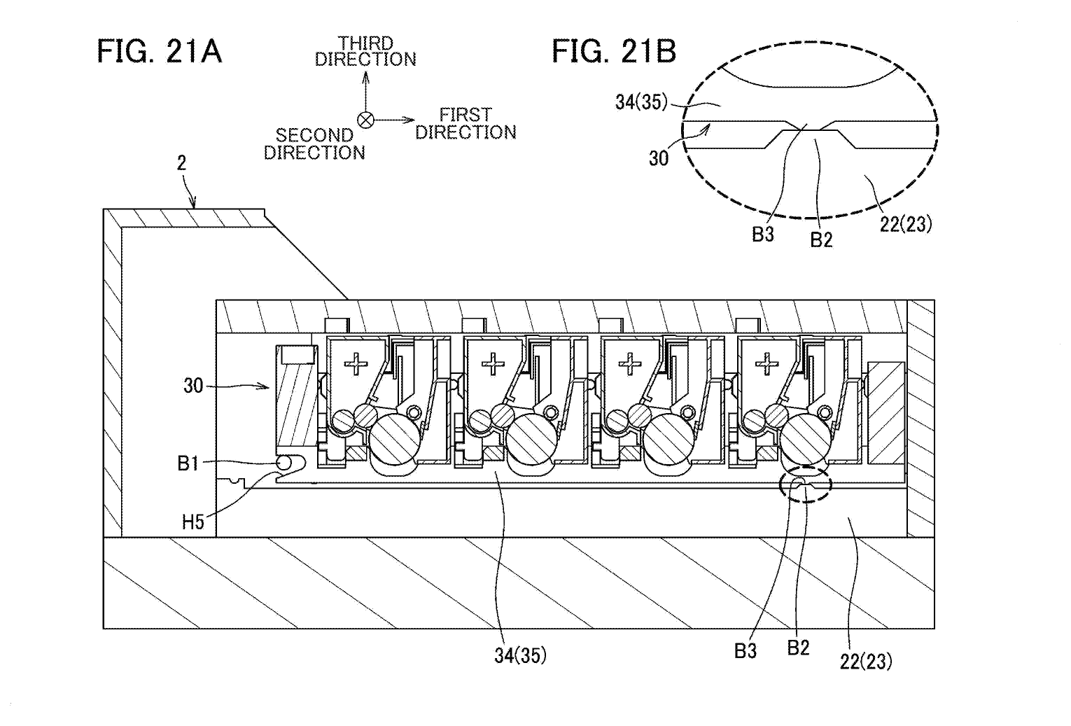

As illustrated in FIGS. 21A and 21B, each of the side frames 22 and 23 includes a main-body protrusion B2. Each main-body protrusion B2 protrudes toward the one side in the third direction.

Each of the fourth wall 34 and fifth wall 35 of the drawer frame 30 has a drawer protrusion B3. Each drawer protrusion B3 protrudes toward the other side in the third direction. The drawer protrusions B3 are positioned at the one end portion of the drawer frame 30 in the first direction. When the drawer 3 is in the attached position, each main-body protrusion B2 is in contact with the corresponding drawer protrusion B3.

The bosses B1 and main-body protrusions B2 support the drawer 3 from the other side in the third direction. The drawer 3 is fixed in position relative to the main housing 2 in the third direction by each boss B1 being received in the corresponding recess H5, as well as by each main-body protrusion B2 contacting the corresponding drawer protrusion B3.

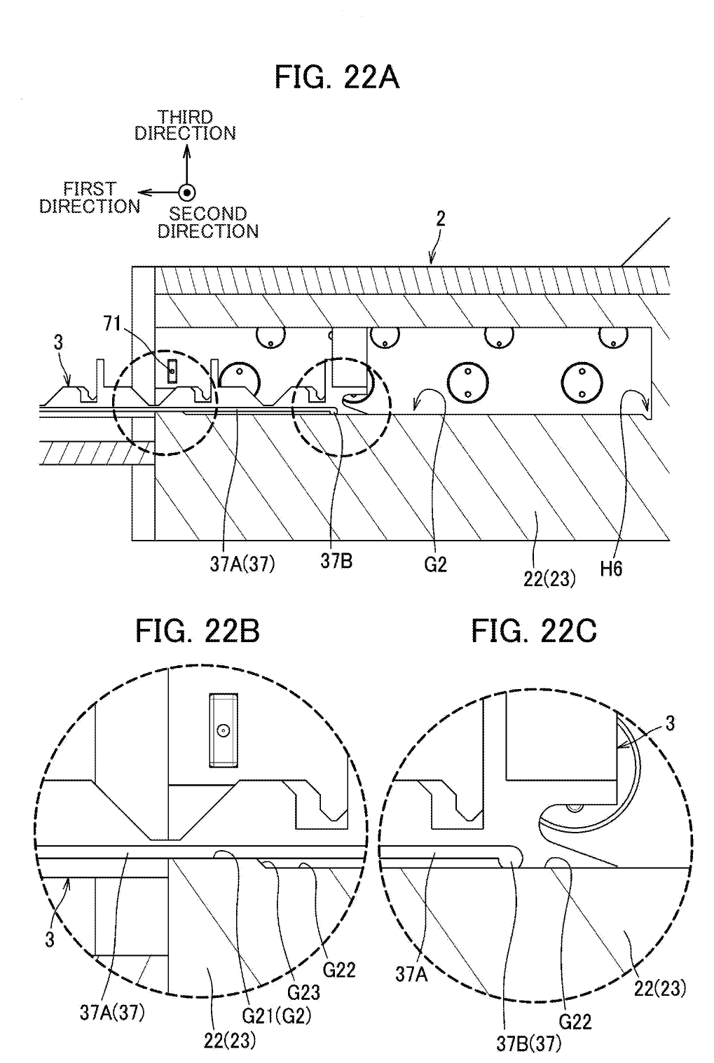

As illustrated in FIG. 22A, the main housing 2 further has a pair of guide surfaces G2 and a pair of recesses H6. Specifically, one guide surface G2 and one recess H6 are formed on each of the side frames 22 and 23. In the following description, only the guide surface G2 and recess H6 on the side frame 22 will be described as a representative example. The guide surface G2 and the recess H6 on the side frame 23 will not be described, since the guide surface G2 and recess H6 on the side frame 23 have a similar structure to those on the side frame 22.

The guide surface G2 is a surface configured to guide the drawer 3. As illustrated in FIG. 22B, the guide surface G2 has a first guide surface G21, a second guide surface G22, and a connecting surface G23. The first guide surface G21 and the second guide surface G22 both extend in the first direction.

The first guide surface G21 is positioned at one end portion of the side frame 22 in the first direction. The first guide surface G21 is configured to contact the base portion 37A of the corresponding guide rail 37 of the drawer 3 while the drawer 3 is positioned somewhere between the pulled-out position and a position prior to the attached position.

The second guide surface G22 is positioned on the other side of the first guide surface G21 in the first direction, and on the other side of the first guide surface G21 in the third direction. As illustrated in FIG. 22C, the second guide surface G22 is configured to contact the protruding portion 37B of the corresponding guide rail 37 while the drawer 3 is positioned somewhere between the pulled-out position and a position prior to the attached position.

The connecting surface G23 connects the other end portion of the first guide surface G21 in the first direction to one end portion of the second guide surface G22 in the first direction. The connecting surface G23 extends, from the other end portion of the first guide surface G21 in the first direction, diagonally toward the other side in the third direction and toward the other side in the first direction. The connecting surface G23 is inclined relative to the first direction.

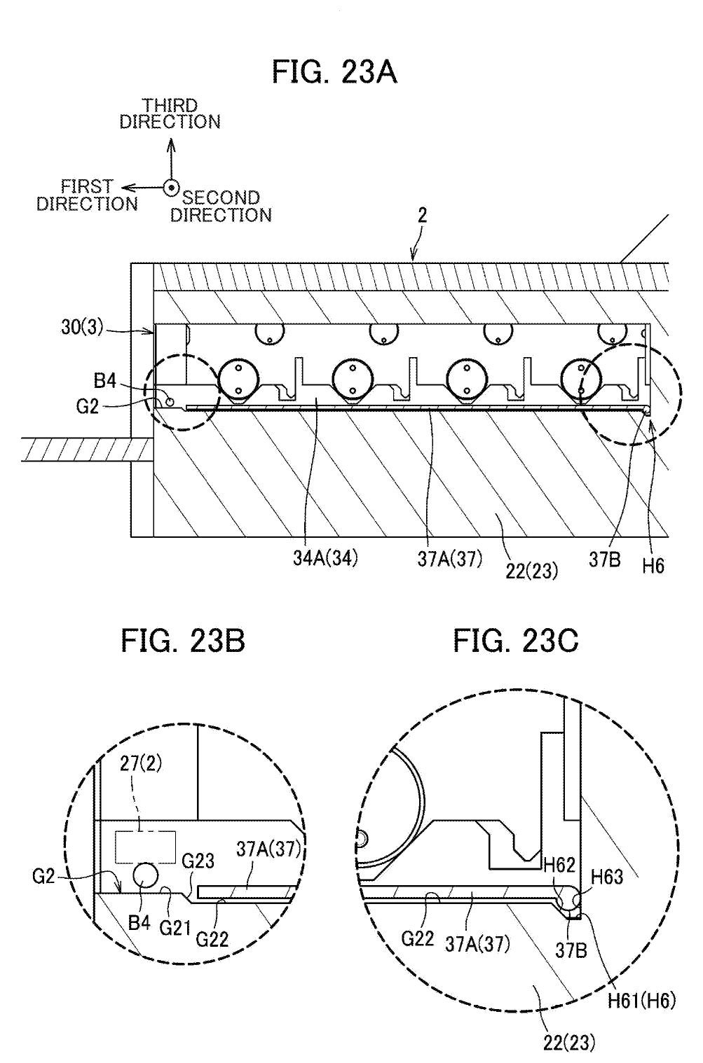

As illustrated in FIG. 23C, the recess H6 is recessed from the second guide surface G22 toward the other side in the third direction. The recess H6 is positioned at the other end portion of the second guide surface G22 in the first direction. The recess H6 has a bottom surface H61, an inclined surface H62, and a vertical surface H63.

The bottom surface H61 is positioned at the other end portion of the recess H6 in the third direction.

The inclined surface H62 extends, from one end portion of the bottom surface H61 in the first direction, diagonally toward the one side in the third direction and toward the one side in the first direction. In other words, the inclined surface H62 extends toward an upstream side in an attaching direction of the drawer 3 to the main housing 2 and toward the one side in the third direction. The inclined surface H62 is inclined relative to the first direction.

The vertical surface H63 extends toward the one side in the third direction from the other end portion of the bottom surface H61 in the first direction. The vertical surface H63 is orthogonal to the first direction.

When the drawer 3 is in the attached position illustrated in FIG. 23A, the protruding portion 37B of the corresponding guide rail 37 is received in the recess H6 as illustrated in FIG. 23C. When the drawer 3 is in the attached position, the protruding portion 37B is in contact with a surface of the main housing 2 that is flush with the vertical surface H63. Here, the surface of the main housing 2 in contact with the protruding portion 37B is positioned at one end portion of the vertical surface H63 in the third direction. When the drawer 3 is in the attached position, the protruding portion 37B is spaced apart from both the bottom surface H61 and the inclined surface H62.

As illustrated in FIG. 23B, when the drawer 3 is in the attached position, the base portion 37A of the corresponding guide rail 37 is positioned on the other side of the first guide surface G21 in the first direction. When the drawer 3 is in the attached position, the base portion 37A is spaced apart from the second guide surface G22 in the third direction.

The guide rail 37 has a length in the first direction that is approximately the same as a distance in the first direction from the first guide surface G21 to the recess H6. Specifically, a distance in the first direction from one end portion of the base portion 37A in the first direction to the other end portion of the protruding portion 37B in the third direction (that is, to a contact point between the protruding portion 37B and the second guide surface G22) is approximately equivalent to a distance in the first direction from one end portion of the connecting surface G23 in the first direction to one end portion of the inclined surface H62 of the recess H6 in the first direction. With this configuration, when the drawer 3 is moving toward the attached position, the timing at which the protruding portion 37B comes into contact with the inclined surface H62 can be approximately the same as the timing at which the one end portion of the base portion 37A in the first direction comes into contact with the connecting surface G23.

At an initial stage of the process of the drawer 3 moving from the pulled-out position to the attached position, the drawer 3 moves in the first direction toward the other side with the base portion 37A supported by the first guide surface G21 and the protruding portion 37B supported by the second guide surface G22. After the one end portion of the base portion 37A in the first direction reaches the connecting surface G23 and the protruding portion 37B reaches the inclined surface H62, the drawer 3 moves, due to its own weight, in a direction slanted relative to the first direction, i.e., diagonally toward the other side in the third direction and toward the other side in the first direction.

As the drawer 3 moves in the direction slanted relative to the first direction, the inner surface of each recess H5 of the drawer 3 comes into contact with the corresponding boss B1 of the main housing 2, and each drawer protrusion B3 comes into contact with the corresponding main-body protrusion B2, as illustrated in FIGS. 21A and 21B. In other words, in a process of the drawer 3 moving in the direction slanted relative to the first direction, a part of the main housing 2 that supports the drawer 3 transitions from the connecting surfaces G23 and the inclined surfaces H62 to the bosses B1 and the main-body protrusions B2. As a result, as illustrated in FIGS. 23B and 23C, the base portion 37A of each guide rail 37 is maintained at a position separated from the corresponding second guide surface G22, and the protruding portion 37B of each guide rail 37 is maintained at a position separated from the corresponding bottom surface H61.

As the drawer 3 moves further toward the other side in the first direction, the protruding portion 37B of each guide rail 37 comes into contact with the surface of the main housing 2 that is flush with the vertical surface H63 of the corresponding recess H6. As a result, the drawer 3 is fixed in position in the first direction relative to the main housing 2, whereby the drawer 3 is placed in the attached position.

As illustrated in FIGS. 23A, 23B, and 7, the drawer frame 30 also includes a pair of bosses B4. One boss B4 is disposed on each of the fourth wall 34 and the fifth wall 35. In the following description, the boss B4 on the fourth wall 34 will be described as a representative example, and the description for the boss B4 on the fifth wall 35 will be omitted since the bosses B4 have a similar structure to each other.

The boss B4 is positioned at one end portion of the side surface 34A of the fourth wall 34 in the first direction. The boss B4 protrudes from the side surface 34A. The boss B4 is arranged at a different position from the corresponding guide rail 37 in both the first and third directions.

Specifically, the boss B4 is positioned further toward the one side in the first direction relative to the corresponding guide rail 37. The boss B4 has a portion positioned further toward the one side in the third direction relative to the corresponding guide rail 37. Incidentally, an entirety of the boss B4 may be positioned further toward the one side in the third direction relative to the corresponding guide rail 37.

As illustrated in FIG. 23B, the main housing 2 also includes a pair of drawer pressing parts 27 each configured to press the corresponding boss B4 of the drawer 3 toward the other side in the third direction. Each drawer pressing part 27 is positioned further toward the one side in the third direction relative to the corresponding boss B4. The drawer pressing part 27 may be a spring, a mechanism including a spring, or a cam pivotable by a motor.

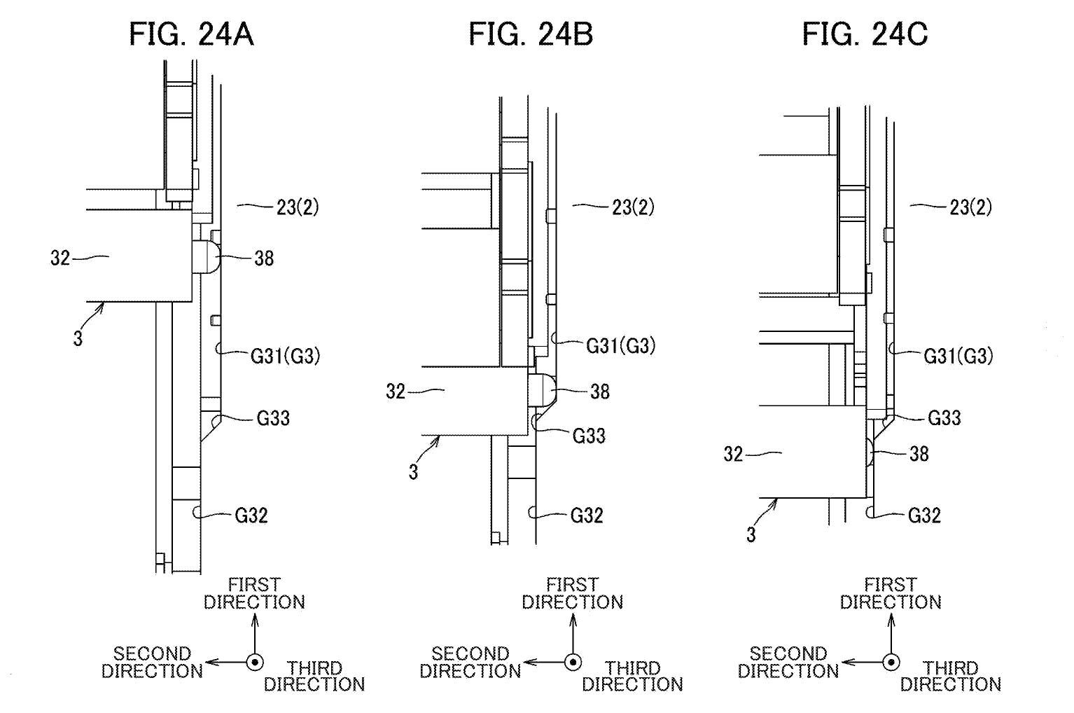

As illustrated in FIGS. 24A through 24C, the side frame 23 has a guide surface G3 configured to guide the pressing projection 38 of the drawer 3 (also see FIG. 6). The guide surface G3 includes a first guide surface G31, a second guide surface G32, and a cam surface G33.

The first guide surface G31 and the second guide surface G32 each extend in the first direction. The second guide surface G32 is positioned further toward the other side in the first direction and toward the one side in the second direction, relative to the first guide surface G31.

The cam surface G33 is a surface functioning to push the pressing projection 38 toward the one side in the second direction. The cam surface G33 extends, from the other end portion of the first guide surface G31 in the first direction, diagonally toward the one side in the second direction and toward the other side in the first direction, and is connected to the second guide surface G32.

Hereinafter, operations of each part of the image-forming apparatus 1 in various situations will be described.

As illustrated in FIG. 17, in a case where the second cartridge 4B is to be attached to the drawer 3 to which the three cartridges 4 other than the second cartridge 4B have already been attached, a user moves the second cartridge 4B such that the one-side contact 210 of the second cartridge electrode 200B of the second cartridge 4B slides along the inclined surface F1 of the first cartridge 4A, as illustrated in FIG. 18A.

Thereafter, as illustrated in FIG. 18B, when the first protrusion C1 of the second cartridge 4B comes into contact with the corresponding guide surface G1, the first protrusion C1 is guided toward the corresponding first recess H1. Subsequently, as illustrated in FIGS. 14A through 15B, the first protrusion C1, the second protrusion C2, the third protrusion C3, and the fourth protrusion C4 of the second cartridge 4B are respectively received in the corresponding first recess H1, second recess H2, third recess H3, and fourth recess H4 of the drawer 3, thereby completing attachment of the second cartridge 4B to the drawer 3.

As illustrated in FIGS. 22A through 22C, as the drawer 3 is moved from the pulled-out position toward the attached position, the drawer 3 first moves in the first direction while being supported by the guide surfaces G2, and then moves diagonally toward the other side in the third direction and toward the other side in the first direction. While moving diagonally, the drawer 3 is supported by the bosses B1 and the main-body protrusions B2, whereby the drawer 3 is fixed in position with respect to the third direction. Finally, as illustrated in FIGS. 23A through 23C, the movement of the drawer 3 is stopped when the protruding portion 37B of each guide rail 37 comes into contact with the corresponding surface of the main housing 2 that is flush with the vertical surface H63 of the corresponding recess H6, thereby completing positioning of the drawer 3 in the first direction relative to the main housing 2.

As illustrated in FIGS. 9A through 9C, in the process of the drawer 3 moving from the pulled-out position to the attached position, the pressing lever 76 pivots, thereby compressing the resilient member 77. As a result, the pressing lever 76 is pressed against and made in contact with the second main-body electrode 72, and the other end portion of the drawer 3 in the first direction is pressed against the respective bosses B1. Further, the one end portion of the drawer 3 in the first direction is pressed by the respective drawer pressing parts 27 illustrated in FIG. 23B, thereby being pressed against the respective main-body protrusions B2 illustrated in FIGS. 21A and 21B.

As illustrated in FIGS. 24A through 24C, in the process of the drawer 3 moving from the pulled-out position to the attached position, the pressing projection 38 is pushed toward the one side in the second direction by the cam surface G33, thereby pushing the pressing projection 38 into the second wall 32. Consequently, the spring interposed between the pressing projection 38 and the second wall 32 is compressed, urging the other end portion of the drawer 3 in the first direction toward the one side in the second direction.

After the user moves the drawer 3 to the attached position and closes the main cover 21, each developing joint J1, each drum joint J2, and the first main-body electrode 71 (illustrated in FIG. 4) are moved toward the one side in the second direction. Consequently, the first main-body electrode 71 is brought into contact with the connector 75 of the drawer 3 illustrated in FIG. 6, while pressing the one end portion of the drawer 3 in the first direction toward the one side in the second direction.

In this way, both the one end portion and the other end portion of the drawer 3 in the first direction are pushed toward the one side in the second direction through the first main-body electrode 71 and the pressing projection 38, respectively. The terminals 33A of the drawer 3 are thus pressed against the corresponding main-body memory electrodes 85 illustrated in FIG. 5 and made in contact with the same.

Further, each developing joint J1 is connected to the corresponding developing coupling CP1, and each drum joint J2 is connected to the corresponding drum coupling CP2. Each developing joint J1 and each drum joint J2 press the corresponding cartridge 4 toward the one side in the second direction. As a result, the electrodes of each cartridge 4 (i.e., the charging electrode 91, drum electrode 92, developing electrode 93, supply electrode 94, and memory electrodes 95 illustrated in FIG. 10) are pressed against and made in contact with the corresponding electrodes of the main housing 2 (i.e., the main-body charging electrode 81, main-body drum electrode 82, main-body developing electrode 83, main-body supply electrode 84, and main-body memory electrodes 85 illustrated in FIG. 5A).

When the drawer 3 is in the attached position as illustrated in FIG. 15A, each cartridge pressing part 26 presses the corresponding cartridge 4 toward the other side in the third direction. Each cartridge 4 is thus pressed against the corresponding third recess H3, fourth recess H4, and second recess H2 (illustrated in FIG. 14A) of the drawer 3.

With the configuration according to the above-described embodiment, the following technical advantages can be achieved.

As illustrated in FIGS. 14A and 14B, the first protrusion C1 of each side cover 130, which includes the cartridge electrode 200, is received in the corresponding first recess H1 of the drawer frame 30 when the cartridges 4 are attached to the drawer 3. Accordingly, positional accuracy of the first cartridge electrode 200A relative to the first drawer electrode 73 can be improved, and positional accuracy of the fourth cartridge electrode 200D relative to the second drawer electrode 74 can also be improved.

Further, since the second protrusion C2 of each cartridge frame 100 is received in the corresponding second recess H2 of the drawer frame 30 when the cartridges 4 are attached to the drawer 3, each cartridge 4 can be fixed in position relative to the drawer frame 30 with high accuracy.

As illustrated in FIGS. 15A and 15B, the third protrusion C3 of each cover 140 is received in the corresponding third recess H3 of the drawer frame 30 when the cartridges 4 are attached to the drawer 3. Hence, accurate positioning of the cartridges 4 relative to the drawer frame 30 can be achieved.

As illustrated in FIGS. 9A through 9C, the resilient member 77 of the drawer 3 presses the drawer 3 against the main housing 2 in conjunction with the insertion of the drawer 3 into the main housing 2. With this configuration, the image-forming apparatus 1 can be made smaller in size, compared to a case where the image-forming apparatus 1 includes an interlocking mechanism configured to interlock movements of the main cover 21 and a pressing member for pressing the drawer 3, for example.

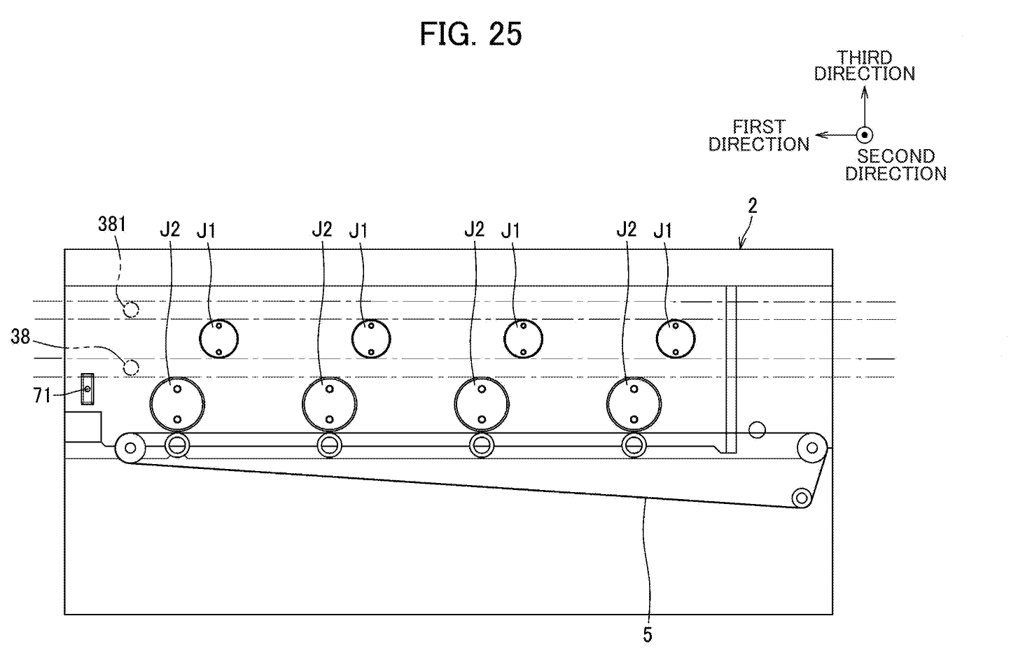

As illustrated in FIG. 15A, the pressing projection 38 is positioned between each developing coupling CP1 and the corresponding drum coupling CP2 in the third direction. Accordingly, the pressing projection 38 can move along a path defined between each developing joint J1 and the corresponding drum joint J2 in the third direction when the drawer 3 moves relative to the main housing 2, as illustrated in FIG. 25. With this configuration, the pressing projection 38 can be restricted from interfering with the developing joints J1 or the drum joints J2 while the drawer 3 moves relative to the main housing 2.

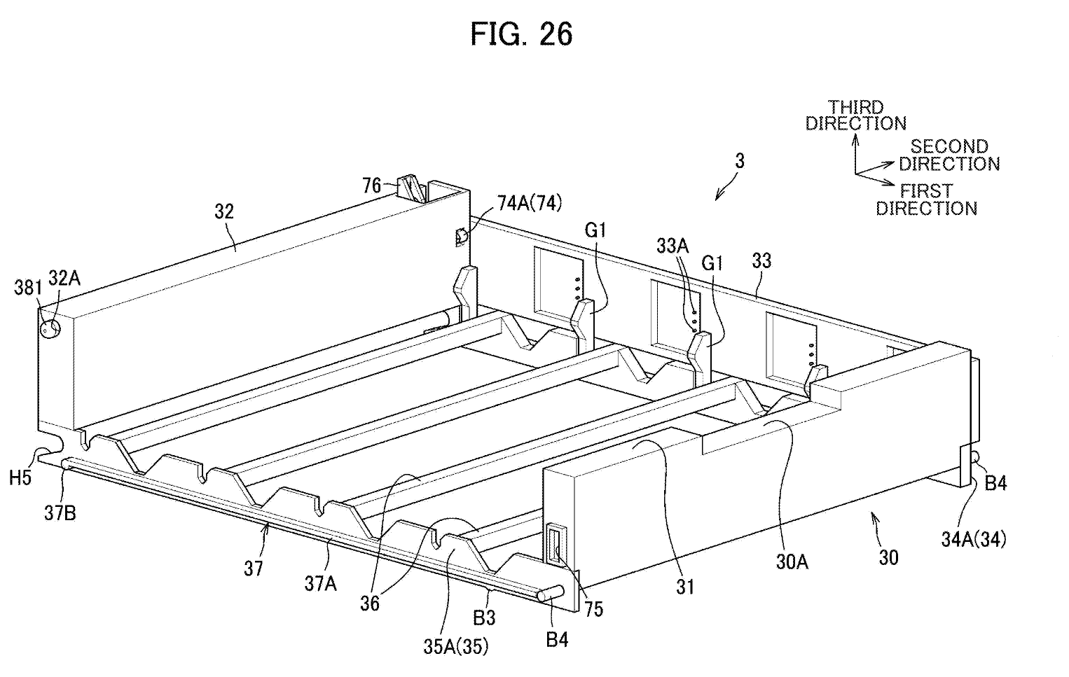

Incidentally, the pressing projection 38 may be arranged at any position in the third direction, provided that the position of the pressing projection 38 is different from the positions of each developing coupling CP1 and the corresponding drum coupling CP2 in the third direction. For example, as illustrated in FIGS. 25 and 26, a pressing projection 381 may be positioned further on the one side of each developing joint J1 and the corresponding drum joint J2 in the third direction. In this case, although not illustrated in the drawings, the pressing projection 381 is positioned further on the one side of each developing coupling CP1 and the corresponding drum coupling CP2 in the third direction.

As illustrated in FIGS. 20A and 20B, each boss B1 of the main housing 2 is received in the corresponding recess H5 of the drawer frame 30 when the drawer 3 is in the attached position. Hence, precise positioning of the drawer 3 relative to the main housing 2 can be realized.

Each of the side frames 22 and 23 supporting the belt unit 5 includes the boss B1 for positioning the drawer 3. With this structure, accurate positioning of the drawer 3 relative to the belt unit 5 can be realized.

As illustrated in FIGS. 21A and 21B, since each main-body protrusion B2 is in contact with the corresponding drawer protrusion B3 when the drawer 3 is in the attached position, the drawer 3 can be accurately positioned relative to the side frames 22 and 23.

As illustrated in FIG. 23C, each recess H6 of the main housing 2 has the inclined surface H62. When the drawer 3 in the attached position is drawn out from the main housing 2, each protruding portion 37B of the drawer 3 slides along the inclined surface H62 of the corresponding recess H6, thereby realizing smooth extraction of the drawer 3 from the main housing 2.

In a state where all the four cartridges 4 are attached to the drawer 3 and the drawer 3 is in the attached position, the first main-body contact 71A illustrated in FIG. 4, the first drawer electrode 73, each of the cartridge electrodes 200, and the second drawer electrode 74 illustrated in FIG. 14A, and the second main-body contact 72A illustrated in FIG. 5 are electrically connected to each other, thereby forming the electrical circuit 7 for supplying power from the first main-body contact 71A to the second main-body contact 72A via the first drawer electrode 73, each cartridge electrode 200, and the second drawer electrode 74. The image-forming apparatus 1 can have the electrical circuit 7 with a novel structure that connects the main housing 2, the drawer 3, and the cartridges 4 to each other.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the following description, components having substantially the same structures as those in the above-described embodiment are designated by the same reference numerals as those in the above-described embodiment, and, thus, descriptions thereof will be omitted.

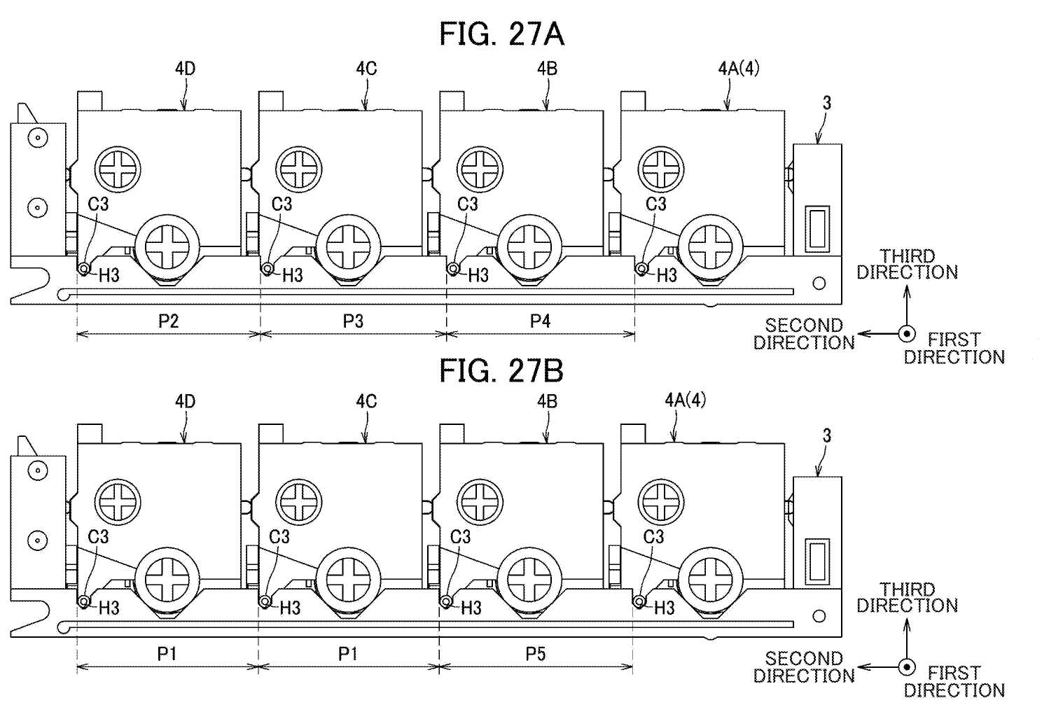

The four third recesses H3 may be arranged in the first direction either at a constant pitch or at different pitches. For example, as illustrated in FIG. 27A, the pitches among the third recesses H3 can be set to P2, P3, and P4, respectively, in order from the other side toward the one side in the first direction in an image-forming apparatus of A-type. Here, the respective pitches can be designed to satisfy the following relationship: P2 < P3 < P4.

Further, as illustrated in FIG. 27B, the pitches among the third recesses H3 may be set to P1, P1, and P5, respectively, in order from the other side toward the one side in the first direction in an image-forming apparatus of B-type different from the A-type image-forming apparatus. Here, the respective pitches can be designed to satisfy the following relationship: P1 < P2 < P3 < P4 < P5. The positions of the third protrusions C3 of the respective cartridges 4 may be so set to correspond to the corresponding third recesses H3.

In this way, by setting the pitches differently among the four third recesses H3 according to the type of each printer, a cartridge 4 for the A-type image-forming apparatus can be restricted from being inadvertently attached to the drawer 3 of the B-type image-forming apparatus, for example. Likewise, this structure can also restrict a cartridge 4 for the B-type image-forming apparatus from being inadvertently attached to the drawer 3 of the A-type image-forming apparatus.

The second direction may be any direction crossing the first direction. The third direction may be any direction crossing both the first and second directions.

Referring to FIG. 19B, the length in the second direction of the inclined surface 260 may be equal to or less than the length in the second direction of the one-side contact 210. In this case, with respect to the position in the second direction, an entirety of the inclined surface 260 may be arranged at the same position as the other-side contact 220. The length in the second direction of the one-side contact 210 may be equal to or greater than the length in the second direction of the other-side contact 220.

The electrical circuit of the disclosure may be used for grounding the photosensitive drum. Specifically, the cartridge electrode of the disclosure may be connected to the photosensitive drum.

The second drawer contact of the disclosure may be made immovable relative to the drawer frame, whereas the first drawer contact of the disclosure may be configured to move in the first direction relative to the drawer frame. The one-side contact of the disclosure may be made immovable relative to the cartridge frame (side cover), whereas the other-side contact of the disclosure may be configured to move in the first direction relative to the cartridge frame (side cover).

The first protrusion of the disclosure may not have a surface orthogonal to the first direction. The first protrusion of the disclosure need not be prismatic in shape, but may have a columnar shape. The first protrusion of the disclosure may not be positioned between the one-side contact and the other-side contact in the first direction.

The pivot axis of the developing frame relative to the drum frame may not be positioned between the first recess and the second recess in the first direction.

The length in the first direction of the first recess may be equal to or greater than the length in the first direction of the second recess. In the third direction, the bottom surface of the first recess may be positioned farther apart from the pivot axis than the bottom surface of the second recess is from the pivot axis.

The third protrusion of the disclosure may not have a cylindrical peripheral surface. The third recess of the disclosure may not have an inclined surface. With respect to the position in the first direction, the third protrusion of the disclosure may not have a part that is at the same position as the first protrusion. In other words, when viewed in the second direction, the third protrusion of the disclosure may not overlap the first protrusion of the disclosure.

The length in the second direction of the third protrusion of the disclosure may be equal to or less than the length in the second direction of the first protrusion of the disclosure.

The resilient member of the disclosure need not be a torsion spring. The resilient member of the disclosure may be, for example, a leaf spring, a wire spring, or a coil spring. The resilient member and the pressing lever of the disclosure may be non-conductive.

The pressing lever of the disclosure may be omitted. If this is the case, the resilient member of the disclosure may be configured as a conductive member that can contact the second main-body contact of the disclosure. Further, the main housing of the disclosure may not have a groove for receiving the pressing lever of the disclosure.

The side surfaces of the drawer frame may face in any direction, provided that the side surfaces of the drawer frame cross the second direction.

The position and shape of each component, such as each electrode, the resilient member, the pressing lever, the connector, the pressing projection, the contact portion, the bosses, and the recesses, need not be limited to those of the described embodiment, and can be modified as appropriate.

The image-forming apparatus of the disclosure may be embodied as a copying machine or a multifunction device.

The elements described in the described embodiment and modifications thereto may be implemented in any combination.

The present disclosure encompasses the following aspects.

(Aspect 1) The disclosure provides an image-forming apparatus including a main housing, a drawer, and a cartridge. The drawer is movable in a first direction relative to the main housing between an attached position in which the drawer is positioned within the main housing and a pulled-out position in which at least a portion of the drawer is positioned outside the main housing. The drawer includes a drawer frame, a handle, and a resilient member. The drawer frame has one end portion and an other end portion in the first direction. The handle is positioned at the one end portion of the drawer frame in the first direction. The resilient member is deformable from a first state to a second state by receiving a force from the main housing while the drawer moves from the pulled-out position to the attached position. The resilient member provides a greater resilient force in the second state than in the first state. The cartridge is attachable to and detachable from the drawer frame. The cartridge includes: a developing roller rotatable about a developing axis extending in a second direction crossing the first direction; and a photosensitive drum rotatable about a drum axis extending in the second direction. Deformation of the resilient member from the first state to the second state causes: the resilient member to press the main housing toward one side in a third direction crossing both the first direction and the second direction; and the drawer to be pressed toward an other side in the third direction by the resilient force of the resilient member.

With this configuration, the resilient member of the drawer presses the drawer against the main housing in conjunction with an attaching operation of the drawer to the main housing. This configuration can restrain an increase in size of the image-forming apparatus, compared to a structure that includes a linkage mechanism configured to interlock movements of a main cover and a pressing member, for example.

(Aspect 2) In the image-forming apparatus according to aspect 1, the resilient member is positioned at the other end portion of the drawer frame in the first direction and at one end portion of the drawer frame in the second direction.

(Aspect 3) In the image-forming apparatus according to aspect 1, the drawer further includes a pressing lever supported by the drawer frame such that the pressing lever is pivotable about a pivot axis extending in the second direction. The resilient member is configured to press the main housing through the pressing lever.

(Aspect 4) In the image-forming apparatus according to aspect 3, the drawer frame includes a boss extending in the second direction. The pressing lever has: a base end portion having an opening through which the boss is inserted; and a tip end portion extending from the base end portion and protruding out relative to the drawer frame.

(Aspect 5) In the image-forming apparatus according to aspect 3, the main housing has a groove extending in the first direction. The groove is configured to receive the pressing lever. In a state where the drawer is in the attached position, the resilient member presses the pressing lever against a bottom surface of the groove.

(Aspect 6) In the image-forming apparatus according to aspect 1, the main housing includes a main-body electrode. The cartridge further includes a cartridge electrode. The resilient member is electrically conductive. The resilient member is configured to be electrically connected to both the main-body electrode and the cartridge electrode.

(Aspect 7) In the image-forming apparatus according to aspect 1, the drawer frame has one end portion and an other end portion in the second direction. The drawer frame includes a pressing projection extending in the second direction. The pressing projection is arranged at the other end portion of the drawer frame in the first direction and at the other end portion of the drawer frame in the second direction. The pressing projection is configured to press the drawer toward one end portion of the main housing in the second direction.

(Aspect 8) In the image-forming apparatus according to aspect 7, the cartridge has one end portion and an other end portion in the second direction. The cartridge further includes a developing coupling and a drum coupling. The developing coupling is configured to transmit a driving force to the developing roller. The developing coupling is positioned at the other end portion of the cartridge in the second direction. The drum coupling is configured to transmit a driving force to the photosensitive drum. The drum coupling is positioned at the other end portion of the cartridge in the second direction. The pressing projection is arranged at a different position from both the developing coupling and the drum coupling in the third direction in a state where the cartridge is attached to the drawer frame.

(Aspect 9) In the image-forming apparatus according to aspect 1, the main housing includes a cartridge pressing part configured to press the cartridge in the third direction.

(Aspect 10) In the image-forming apparatus according to aspect 9, the drawer frame has two recesses for positioning the cartridge relative to the drawer frame. The two recesses are arranged in the first direction. The cartridge further includes a contact portion configured to contact the cartridge pressing part. The contact portion is positioned between the two recesses in the first direction in a state where the cartridge is attached to the drawer frame.

(Aspect 11) In the image-forming apparatus according to aspect 1, the main housing includes two bosses extending in the second direction. The two bosses are spaced apart from each other in the second direction. The drawer frame has two recesses spaced apart from each other in the second direction. The two recesses are recessed in the first direction. The two recesses are positioned at the other end portion of the drawer frame in the first direction. Each of the two bosses is received in a corresponding one of the two recesses in a state where the drawer is in the attached position.

(Aspect 12) The image-forming apparatus according to aspect 11 further includes a belt unit that includes a belt configured to contact the photosensitive drum. The main housing includes a pair of side frames configured to support the belt unit. One of the two bosses is positioned at a corresponding one of the side frames, and a remaining one of the two bosses is positioned at a remaining one of the side frames.

(Aspect 13) In the image-forming apparatus according to aspect 12, each of the side frames has a main-body protrusion protruding toward the one side in the third direction. The drawer frame includes a pair of drawer protrusions protruding toward the other side in the third direction. In a state where the drawer is in the attached position, the main-body protrusion of each side frame is in contact with a corresponding one of the drawer protrusions.

(Aspect 14) In the image-forming apparatus according to aspect 1, the drawer frame has a side surface crossing the second direction. The drawer frame includes a guide rail protruding from the side surface and extending in the first direction. The guide rail is configured to be guided by the main housing.

(Aspect 15) In the image-forming apparatus according to aspect 14, the guide rail has a protruding portion protruding in the third direction and having a curved shape in a side view. The protruding portion is positioned at an end portion of the guide rail in the first direction. The main housing has a recess recessed in the third direction. The protruding portion is received in the recess in a state where the drawer is in the attached position.

(Aspect 16) In the image-forming apparatus according to aspect 15, the recess has an inclined surface inclined relative to the first direction to extend toward the one side in the third direction and toward an upstream side in an attaching direction of the drawer to the main housing.

(Aspect 17) In the image-forming apparatus according to aspect 14, the drawer frame includes a boss positioned at one end portion of the side surface in the first direction. The boss protrudes from the side surface. The main housing includes a drawer pressing part configured to press the boss in the third direction.

(Aspect 18) In the image-forming apparatus according to aspect 17, the boss is arranged at a different position from the guide rail in the third direction.

(Aspect 19) In the image-forming apparatus according to aspect 1, the cartridge is configured to be attached to the drawer frame toward the other side in the third direction and to be detached from the drawer frame toward the one side in the third direction.

(Aspect 20) In the image-forming apparatus according to aspect 1, the cartridge has one end portion and an other end portion in the third direction. The photosensitive drum is positioned at the other end portion of the cartridge in the third direction.

(Aspect 21) The disclosure also provides an image-forming apparatus including a main housing, a drawer, a first cartridge, and a second cartridge. The main housing includes a first main-body contact and a second main-body contact. The drawer is movable in a first direction relative to the main housing. The drawer includes: a drawer frame, a first drawer electrode, and a second drawer electrode. The first drawer electrode is positioned at one end portion of the drawer frame in the first direction. The first drawer electrode is configured to be electrically connected to the first main-body contact. The second drawer electrode is positioned at an other end portion of the drawer frame in the first direction. The second drawer electrode is configured to be electrically connected to the second main-body contact. The first cartridge is attachable to and detachable from the drawer. The first cartridge includes a first cartridge frame, a first developing roller, a first photosensitive drum, and a first cartridge electrode. The first developing roller includes a first developing shaft extending in a second direction crossing the first direction. The first photosensitive drum includes a first drum shaft extending in the second direction. The second cartridge is attachable to and detachable from the drawer. The first cartridge and the second cartridge are arranged in the first direction in a state where the first cartridge and the second cartridge are attached to the drawer. The second cartridge includes a second cartridge frame, a second developing roller, a second photosensitive drum, and a second cartridge electrode. The second developing roller includes a second developing shaft extending in the second direction. The second photosensitive drum includes a second drum shaft extending in the second direction. The first cartridge electrode has: a first one-side contact positioned at one end portion of the first cartridge frame in the first direction; a first other-side contact positioned at an other end portion of the first cartridge frame in the first direction; and a first electrode body extending from the first one-side contact to the first other-side contact. The second cartridge electrode has: a second one-side contact positioned at one end portion of the second cartridge frame in the first direction; a second other-side contact positioned at an other end portion of the second cartridge frame in the first direction; and a second electrode body extending from the second one-side contact to the second other-side contact. In a state where both the first cartridge and the second cartridge are attached to the drawer, the first drawer electrode is electrically connected to the first one-side contact; the first other-side contact is electrically connected to the second one-side contact; and the second other-side contact is electrically connected to the second drawer electrode.

In the image-forming apparatus with the above-identified configuration, the first main-body contact, the first drawer electrode, the first cartridge electrode, the second cartridge electrode, the second drawer electrode, and the second main-body contact are electrically connected to each other in a state where both the first cartridge and the second cartridge are attached to the drawer and the drawer is attached to the main housing. With this configuration, an electrical circuit is formed in the image-forming apparatus for supplying power from the first main-body contact to the second main-body contact through the first drawer electrode, the first cartridge electrode, and the second cartridge electrode, and the second drawer electrode. Therefore, the image-forming apparatus can have an electrical circuit of a novel configuration that passes through the main housing, the drawer, the first cartridge, and the second cartridge.

(Aspect 22) In the image-forming apparatus according to aspect 21, the first one-side contact is movable in the first direction relative to the first cartridge frame.

(Aspect 23) In the image-forming apparatus according to aspect 21, the first cartridge further includes: a first developing coupling configured to transmit a driving force to the first developing roller; and a first drum coupling configured to transmit a driving force to the first photosensitive drum. The first cartridge electrode is positioned at one end portion of the first cartridge frame in the second direction; the first developing coupling and the first drum coupling are positioned at an other end portion of the first cartridge frame in the second direction.

(Aspect 24) In the image-forming apparatus according to aspect 23, the first cartridge further includes a first developing electrode electrically connected to the first developing shaft. The first developing electrode is positioned at the one end portion of the first cartridge frame in the second direction.

(Aspect 25) In the image-forming apparatus according to aspect 23, the first cartridge frame includes: a first drum frame rotatably supporting the first drum shaft; a first developing frame rotatably supporting the first developing shaft; and a first side cover holding both the first drum frame and the first developing frame. The first developing frame is pivotable relative to the first drum frame. The first side cover is positioned at the one end portion of the first cartridge frame in the second direction. The first cartridge electrode is positioned at the first side cover.

(Aspect 26) In the image-forming apparatus according to aspect 21, the first cartridge has an inclined surface positioned at the other end portion of the first cartridge frame in the first direction. The inclined surface is inclined relative to the first direction. At least a part of the inclined surface is at the same position as the first other-side contact in the second direction. The inclined surface is positioned upstream relative to the first other-side contact in an attaching direction of the first cartridge to the drawer.

(Aspect 27) In the image-forming apparatus according to aspect 26, the inclined surface has a length in the second direction that is longer than a length in the second direction of the first one-side contact.

(Aspect 28) In the image-forming apparatus according to aspect 27, the length in the second direction of the first one-side contact is shorter than a length in the second direction of the first other-side contact.

(Aspect 29) In the image-forming apparatus according to aspect 21, the first drawer electrode has a first drawer contact configured to be electrically connected to the first one-side contact of the first cartridge. The second drawer electrode has a second drawer contact configured to be electrically connected to the second other-side contact of the second cartridge.

(Aspect 30) In the image-forming apparatus according to aspect 29, the second drawer contact is movable in the first direction relative to the drawer frame.

(Aspect 31) In the image-forming apparatus according to aspect 29, the drawer further includes a connector electrically connected to the first drawer electrode. The connector is configured to receive power from the first main-body contact. The second drawer contact is positioned at one end portion of the drawer frame in the second direction. The connector is positioned at an other end portion of the drawer frame in the second direction.

(Aspect 32) In the image-forming apparatus according to aspect 29, the drawer further includes a conductive member electrically connected to the second drawer electrode. The conductive member is positioned at the other end portion of the drawer frame in the first direction. The conductive member protrudes out relative to the drawer frame in a third direction crossing both the first direction and the second direction.

(Aspect 33) In the image-forming apparatus according to aspect 32, the drawer further includes a conductive spring electrically connected to both the second drawer electrode and the conductive member. The conductive spring is configured to urge the conductive member such that the conductive member is pressed against the second main-body contact in a state where the drawer is attached to the main housing.

(Aspect 34) The image-forming apparatus according to aspect 29 further includes a controller. A plurality of cartridges including the first cartridge and the second cartridge is attachable to and detachable from the drawer. An electrical circuit is formed in a state where all of the cartridges are attached to the drawer and the drawer is attached to the main housing. The electrical circuit includes the first main-body contact, the first drawer electrode, the first cartridge electrode, the second cartridge electrode, the second drawer electrode, and the second main-body contact. Based on whether a current flows between the first main-body contact and the second main-body contact, the controller is configured to determine whether all of the cartridges are attached to the drawer.

(Aspect 35) In the image-forming apparatus according to aspect 29, the drawer frame has a guide surface configured to guide the first cartridge in a third direction crossing both the first direction and the second direction. The first cartridge frame has a contact surface configured to contact the guide surface and be guided by the guide surface. The contact surface is positioned downstream relative to the first other-side contact in an attaching direction of the first cartridge to the drawer.

(Aspect 36) In the image-forming apparatus according to aspect 29, the drawer includes a handle positioned at the one end portion of the drawer frame in the first direction.

(Aspect 37) In the image-forming apparatus according to aspect 21, the first direction is orthogonal to the second direction.

(Aspect 38) In the image-forming apparatus according to aspect 21, the second cartridge electrode has a resilient part configured to urge the first cartridge in the first direction.

What is claimed is:

1. An image-forming apparatus comprising:
a main housing including a first main-body contact and a second main-body contact;
a drawer movable in a first direction relative to the main housing, the drawer including:
a drawer frame;
a first drawer electrode configured to be electrically connected to the first main-body contact; and
a second drawer electrode configured to be electrically connected to the second main-body contact; and
a cartridge attachable to and detachable from the drawer, the cartridge including:
a developing roller including a developing shaft extending in a second direction crossing the first direction;
a photosensitive drum including a drum shaft extending in the second direction;
a side cover positioned at one end portion of the developing roller in the second direction; and
a cartridge electrode configured to be electrically connected to both the first drawer electrode and the second drawer electrode, the cartridge electrode being positioned at the side cover,
wherein the drawer frame has a first recess recessed in a third direction crossing both the first direction and the second direction, and
wherein the side cover has a first protrusion protruding in the third direction, the first protrusion being configured to be received in the first recess.

2. The image-forming apparatus according to claim 1,
wherein the first protrusion has a surface orthogonal to the first direction.

3. The image-forming apparatus according to claim 1,
wherein the cartridge further includes a cartridge frame rotatably supporting both the developing shaft and the drum shaft,
wherein the cartridge electrode includes:
a one-side contact positioned at one end portion of the cartridge frame in the first direction; and
an other-side contact positioned at an other end portion of the cartridge frame in the first direction, and
wherein the first protrusion is positioned between the one-side contact and the other-side contact in the first direction.

4. The image-forming apparatus according to claim 1,
wherein the cartridge further includes a cartridge frame, the cartridge frame including:
a developing frame rotatably supporting the developing shaft; and
a drum frame rotatably supporting the drum shaft, the developing frame being pivotable relative to the drum frame about a pivot axis extending in the second direction,
wherein the drawer frame includes a second recess recessed in the third direction,
wherein the cartridge frame further has a second protrusion protruding in the third direction, the second protrusion being configured to be received in the second recess, and
wherein the pivot axis is positioned between the first recess and the second recess in the first direction in a state where the cartridge is attached to the drawer.

5. The image-forming apparatus according to claim 4,
wherein the first recess has a length in the first direction that is shorter than a length in the first direction of the second recess.

6. The image-forming apparatus according to claim 4,
wherein the first recess has a bottom surface and the second recess has a bottom surface, and
wherein, in a state where the cartridge is attached to the drawer,
the bottom surface of the first recess is positioned closer to the pivot axis in the third direction than the bottom surface of the second recess is to the pivot axis.

7. The image-forming apparatus according to claim 1,
wherein the cartridge further includes a cartridge frame having one end portion and an other end portion in the second direction, the cartridge frame including:
a developing frame rotatably supporting the developing shaft;
a drum frame rotatably supporting the drum shaft; and
a cover holding both the developing frame and the drum frame, the cover being positioned at the other end portion of the cartridge frame in the second direction,
wherein the drawer frame has a third recess recessed in the third direction, and
wherein the cover has a third protrusion configured to be received in the third recess.

8. The image-forming apparatus according to claim 7,
wherein the third protrusion has a cylindrical peripheral surface extending in the second direction, the cylindrical peripheral surface being configured to contact the third recess.

9. The image-forming apparatus according to claim 7,
wherein the third recess has an inclined surface inclined relative to the first direction.

10. The image-forming apparatus according to claim 7,
wherein a portion of the first protrusion and a portion of the third protrusion are at the same position in the first direction.

11. The image-forming apparatus according to claim 7,
wherein the third protrusion has a length in the second direction that is longer than a length in the second direction of the first protrusion.
